(19) United States
(12) Patent Application Publication
(10) Pub. No.: US 2022/0251379 A1
(43) Pub. Date: Aug. 11, 2022

(54) POLYURETHANE RESIN COMPOSITION AND MOLDED ARTICLE

(71) Applicant: MITSUI CHEMICALS, INC., Tokyo (JP)

(72) Inventors: Hiroaki TAGO, Chiba-shi, CHIBA (JP); Satoshi KUROIWA, Chiba-shi, CHIBA (JP); Takeshi KOBAYASHI, Chiba-shi, CHIBA (JP); Hiroshi KANAYAMA, Chiba-shi, CHIBA (JP)

(21) Appl. No.: 17/628,623

(22) PCT Filed: Jul. 31, 2020
(86) PCT No.: PCT/JP2020/029379

§ 371 Date: Jan. 20, 2022

(30) Foreign Application Priority Data
Aug. 7, 2019 (JP) 2019-145643
Apr. 28, 2020 (JP) 2020-079200

(51) Int. Cl. C08L 75/06

(52) U.S. Cl. CPC C08L 75/06; C08L 2205/035

(57) ABSTRACT

A polyurethane resin composition includes a reaction product of a polyisocyanate component and a polyol component, and a wax. The polyisocyanate component contains a highly symmetrical polyisocyanate. The polyol component contains a polycarbonate polyol having a number average molecular weight of 600 or more and 1200 or less and a polyester polyol having a number average molecular weight of 600 or more and 1200 or less. A ratio of the polycarbonate polyol is 3 parts by mass or more and 40 parts by mass or less, and a ratio of the polyester polyol is 60 parts by mass or more and 97 parts by mass or less with respect to 100 parts by mass of the total amount of the polycarbonate polyol and the polyester polyol.

### TECHNICAL FIELD

The present invention relates to a polyurethane resin composition and a molded article, to be specific, to a polyurethane resin composition and a molded article obtained by molding the polyurethane resin composition.

### BACKGROUND ART

A thermoplastic polyurethane resin (TPU) is generally a rubber elastic product obtained by a reaction of a polyisocyanate, a high molecular weight polyol, and a low molecular weight polyol, and includes a hard segment formed by a reaction of the polyisocyanate and the low molecular weight polyol and a soft segment formed by a reaction of the polyisocyanate and the high molecular weight polyol. By melt molding such a thermoplastic polyurethane resin, a molded article made of a polyurethane resin can be obtained.

Specifically, as a polyurethane resin, a polyurethane resin obtained by reacting an isocyanate group-terminated prepolymer obtained by reacting a 1,4-bis(isocyanatomethyl)cyclohexane with a polybutylene adipate having a number average molecular weight of 1000 and a polycarbonate diol having a number average molecular weight of 1000 with the polybutylene adipate at a smaller ratio (polybutylene adipate:polycarbonate diol=25:75 (mass ratio)) with respect to the polycarbonate diol; and a 1,4-butanediol has been proposed (ref: for example, Patent Document 1 (Synthesis Examples 26 to 27 and Examples 22 to 23)).

### CITATION LIST

### Patent Document

Patent Document 1: International Publication WO2019/069802

### SUMMARY OF THE INVENTION

### Problem to be Solved by the Invention

On the other hand, a polyurethane elastomer and a molded article thereof require further improvement in properties in accordance with the application, and for example, in the field such as a cover for a smart device, the improvement in bloom resistance in the moist heat environment is required. In addition, from the viewpoint of production efficiency, the improvement in demoldability is required for the polyurethane elastomer and the molded article thereof.

The present invention provides a polyurethane resin composition having excellent bloom resistance in the moist heat environment and demoldability, and a molded article obtained from the polyurethane resin composition.

### Means for Solving the Problem

The present invention [1] includes a polyurethane resin composition including a reaction product of a polyisocyanate component and a polyol component, and a wax, wherein the polyisocyanate component contains a highly symmetrical polyisocyanate: the polyol component contains a polycarbonate polyol having a number average molecular weight of 600 or more and 1200 or less and a polyester polyol having a number average molecular weight of 600 or more and 1200 or less; and a ratio of the polycarbonate polyol is 3 parts by mass or more and 40 parts by mass or less, and a ratio of the polyester polyol is 60 parts by mass or more and 97 parts by mass or less with respect to 100 parts by mass of the total amount of the polycarbonate polyol and the polyester polyol.

The present invention [2] includes the polyurethane resin composition described in the above-described [1], wherein a temperature at which the viscosity of the polyurethane resin composition is 2000 Pa·s is 185° C. or more and 225° C. or less.

The present invention [3] includes the polyurethane resin composition described in the above-described [1] or [2], wherein the highly symmetrical polyisocyanate includes a 1,4-bis(isocyanatomethyl)cyclohexane or a 4,4′-diphenylmethane diisocyanate.

The present invention [4] includes the polyurethane resin composition described in any one of the above-described [1] to [3], wherein the highly symmetrical polyisocyanate includes a 1,4-bis(isocyanatomethyl)cyclohexane.

The present invention [5] includes the polyurethane resin composition described in any one of the above-described [1] to [4], wherein the polyester polyol includes a polycaprolactone polyol.

The present invention [6] includes the polyurethane resin composition described in any one of the above-described [1] to [5], wherein a number average molecular weight of the polycarbonate polyol is 600 or more and 1000 or less, and a number average molecular weight of the polyester polyol is 1000 or more and 1200 or less.

The present invention [7] includes the polyurethane resin composition described in any one of the above-described [1] to [6], wherein a content ratio of the wax is 0.005 parts by mass or more and 0.15 parts by mass or less with respect to 100 parts by mass of the total amount of the polyisocyanate component and the polyol component.

The present invention [8] includes the polyurethane resin composition described in any one of the above-described [1] to [7], wherein the wax includes at least one kind selected from the group consisting of a polyolefin-based wax, a fatty acid ester-based wax, and a fatty acid amide-based wax.

The present invention [9] includes the polyurethane resin composition described in the above-described [8], wherein the wax includes a polyolefin-based wax, and the melt viscosity at 150° C. of the polyolefin-based wax is 10 mPa·s or more and 100 mPa·s or less.

The present invention [10] includes the polyurethane resin composition described in the above-described [8], wherein the wax includes a fatty acid ester-based wax and/or a fatty acid amide-based wax, and the melt viscosity at 190° C. of the fatty acid ester-based wax and the fatty acid amide-based wax is 10 mPa·s or more and 100 mPa·s or less.

The present invention [11] includes the polyurethane resin composition described in any one of claims [8] to [10], wherein the wax includes two or more kinds selected from the group consisting of a polyolefin-based wax, a fatty acid ester-based wax, and a fatty acid amide-based wax.

The present invention [12] includes a molded article including the polyurethane resin composition described in any one of the above-described [1] to [11].

The present invention [13] includes the molded article described in the above-described [12] being a cover for a smart device.

### Effect of the Invention

A polyurethane resin composition and a molded article thereof of the present invention contain a reaction product of a polyisocyanate component and a polyol component, and a wax; the polyisocyanate component contains a highly symmetrical polyisocyanate; and the polyol component contains a polycarbonate polyol having a predetermined molecular weight and a polyester polyol having a predetermined molecular weight. Furthermore, in the polyurethane resin composition and the molded article thereof of the present invention, a ratio of the polyester polyol is adjusted to be excessive with respect to that of the polycarbonate polyol.

Therefore, the polyurethane resin composition and the molded article thereof have excellent bloom resistance in the moist heat environment and demoldability.

### DESCRIPTION OF EMBODIMENTS

A polyurethane resin composition of the present invention is a thermoplastic polyurethane resin composition or a thermosetting polyurethane resin composition, and is preferably a thermoplastic polyurethane resin composition.

The thermoplastic polyurethane resin composition contains a thermoplastic polyurethane resin which is a reaction product of a polyisocyanate component and a polyol component, and a wax to be described later.

The thermoplastic polyurethane resin is obtained as a reaction product by reacting the polyisocyanate component with the polyol component.

The polyisocyanate component contains a highly symmetrical polyisocyanate as an essential component.

The highly symmetrical polyisocyanate is a polyisocyanate compound having symmetry in a steric structure of a molecule, and is a polyisocyanate compound capable of exhibiting a chemical structural formula so as to be X-axially symmetrical and Y-axially symmetrical on an X-Y plane. Examples of the highly symmetrical polyisocyanate include a 1,4-bis(isocyanatomethyl)cyclohexane (1,4-H₆XDI) and a 4,4′-diphenylmethane diisocyanate (4,4′-MDI). These may be used alone or in combination of two or more.

That is, the polyisocyanate component contains a 1,4-bis(isocyanatomethyl)cyclohexane and/or a 4,4′-diphenylmethane diisocyanate.

Since the 1,4-bis(isocyanatomethyl)cyclohexane and the 4,4′-diphenylmethane diisocyanate each have a molecular structure having high symmetry sterically, when the polyisocyanate component contains these, it is possible to obtain excellent demoldability, and in addition, to improve mechanical properties.

The polyisocyanate component further preferably contains a 1,4-bis(isocyanatomethyl)cyclohexane from the viewpoint of discoloration resistance.

Examples of the 1,4-bis(isocyanatomethyl)cyclohexane include stereoisomers of a cis-1,4-bis(isocyanatomethyl)cyclohexane (hereinafter, referred to as a cis-1,4 isomer) and a trans-1,4-bis(isocyanatomethyl)cyclohexane (hereinafter, referred to as a trans-1,4 isomer). In the 1,4-bis(isocyanatomethyl)cyclohexane, a content ratio of the trans-1,4 isomer is, for example, 60 mol % or more, preferably 70 mol % or more, more preferably 80 mol % or more, further more preferably 85 mol % or more, and is, for example, 99.8 mol % or less, preferably 99 mol % or less, more preferably 96 mol % or less, further more preferably 90 mol % or less. In other words, since the 1,4-bis(isocyanatomethyl)cyclohexane has the total amount of the trans-1,4 isomer and the cis-1,4 isomer of 100 mol %, a content ratio of the cis-1,4 isomer is, for example, 0.2 mol % or more, preferably 1 mol % or more, more preferably 4 mol % or more, further more preferably 10 mol % or more, and is, for example, 40 mol % or less, preferably 30 mol % or less, more preferably 20 mol % or less, further more preferably 15 mol % or less.

When the content ratio of the trans-1,4 isomer is the above-described lower limit or more, it is possible to improve molding stability, the mechanical properties, stain resistance, and the discoloration resistance. Further, when the content ratio of the trans-1,4 isomer is the above-described upper limit or less, it is possible to improve the mechanical properties, transparency, bloom resistance, and the discoloration resistance.

The 1,4-bis(isocyanatomethyl)cyclohexane can be, for example, produced by the method described in International Publication WO2019/069802 and the like.

Further, the polyisocyanate component may contain another polyisocyanate (polyisocyanate excluding the highly symmetrical polyisocyanate) as an arbitrary component as long as it does not damage the excellent effect of the present invention.

Examples of the other polyisocyanate include aliphatic polyisocyanates, aromatic polyisocyanates, and araliphatic polyisocyanates.

Examples of the aliphatic polyisocyanate include chain aliphatic diisocyanates such as ethylene diisocyanate, trimethylene diisocyanate, tetramethylene diisocyanate, pentamethylene diisocyanate (PDI), hexamethylene diisocyanate (HDI), octamethylene diisocyanate, nonamethylene diisocyanate, 2,2′dimethylpentane diisocyanate, 2,2,4-trimethylhexanediisocyanate, decamethylene diisocyanate, butene diisocyanate, 1,3-butadiene-1,4-diisocyanate, 2,4,4-trimethylhexamethylene diisocyanate, 1,6,11-undecamethylene triisocyanate, 1,3,6-hexamethylene triisocyanate, 1,8-diisocyanate-4-isocyanatomethyloctane, 2,5,7-trimethyl-1,8-diisocyanate-5-isocyanatomethyloctane, bis(isocyanatoethyl)carbonate, bis(isocyanatoethyl)ether, 1,4-butyleneglycoldipropylether-ω,ω′-diisocyanate, lysine isocyanatomethyl ester, lysine triisocyanate, 2-isocyanatoethyl-2,6-diisocyanatehexanoate, 2-isocyanatopropyl-2,6-diisocyanatehexanoate, bis(4-isocyanate-n-butylidene)pentaerythritol, and 2,6-diisocyanatemethylcaproate.

An example of the aliphatic polyisocyanate includes an alicyclic polyisocyanate (excluding the 1,4-bis(isocyanatomethyl)cyclohexane).

Examples of the alicyclic polyisocyanate (excluding the 1,4-bis(isocyanatomethyl)cyclohexane) include alicyclic diisocyanates such as 1,3-bis(isocyanatomethyl)cyclohexane (1,3-H₆XDI), isophorone diisocyanate (IPDI), trans,trans-, trans,cis-, and cis,cis-dicyclohexylmethane diisocyanate and a mixture thereof (hydrogenated MDI), 1,3- or 1,4-cyclohexane diisocyanate and a mixture thereof, 1,3- or 1,4-bis(isocyanatoethyl)cyclohexane, methylcyclohexane diisocyanate, 2,2′-dimethyldicyclohexylmethane diisocyanate, dimer acid diisocyanate, 2,5-diisocyanatomethylbicyclo[2,2,1]-heptane and 2,6-diisocyanatomethylbicyclo[2,2,1]-heptane (NBDI) which is its isomer, 2-isocyanatomethyl-2-(3-isocyanatopropyl)-5-isocyanatomethylbicyclo-[2,2,1]-heptane, 2-isocyanatomethyl-2-(3-isocyanatopropyl)-6-isocyanatomethylbicyclo-[2,2,1]-heptane, 2-isocyanatomethyl-3-(3-isocyanatopropyl)-5-(2-isocyanatoethyl)-bicyclo-[2,2,1]-heptane, 2-isocyanatomethyl-3-(3-isocyanatopropyl)-6-(2-isocyanatoethyl)-bicyclo-[2,2,1]-heptane, 2-isocyanatomethyl-2-(3-isocyanatopropyl)-5-(2-isocyanatoethyl)-bicyclo-[2,2,1]-heptane, and 2-isocyanatomethyl-2-(3-isocyanatopropyl)-6-(2-isocyanatoethyl)-bicyclo-[2,2,1]-heptane.

Examples of the aromatic polyisocyanate (excluding the 4,4′-diphenylmethane diisocyanate) include aromatic diisocyanates such as 2,4-tolylene diisocyanate and 2,6-tolylene diisocyanate, and isomer mixtures of these tolylene diisocyanates (TDI), 2,4′-diphenylmethane diisocyanate (2,4′-MDI) and 2,2′-diphenylmethane diisocyanate (2,2′-MDI), and arbitrary isomer mixtures of these diphenylmethane diisocyanates, toluidine diisocyanate (TODI), paraphenylene diisocyanate, and naphthalene diisocyanate (NDI).

Examples of the araliphatic polyisocyanate include araliphatic diisocyanates such as 1,3- or 1,4-xylylene diisocyanate and a mixture of these (XDI), and 1,3- or 1,4-tetramethylxylylene diisocyanate and a mixture of these (TMXDI).

These other polyisocyanates may be used alone or in combination of two or more.

A content ratio of the other polyisocyanate, if included, is, for example, 50% by mass or less, preferably 30% by mass or less, more preferably 20% by mass or less with respect to the total amount of the polyisocyanate component.

From the viewpoint of demoldability, the polyisocyanate component preferably does not contain the other polyisocyanate and consists of a highly symmetrical polyisocyanate, more preferably consists of a 1,4-bis(isocyanatomethyl)cyclohexane and/or a 4,4′-diphenylmethane diisocyanate, further more preferably consists of a 1,4-bis(isocyanatomethyl)cyclohexane or a 4,4′-diphenylmethane diisocyanate.

In other words, as the polyisocyanate component, from the viewpoint of demoldability, further more preferably, a 1,4-bis(isocyanatomethyl)cyclohexane is used alone, or a 4,4′-diphenylmethane diisocyanate is used alone, particularly preferably, a 1,4-bis(isocyanatomethyl)cyclohexane is used alone.

The polyol component is a component consisting of a compound having two or more hydroxyl groups in a molecule (hereinafter, may be referred to as a polyol).

In the following, a polyol having a number average molecular weight of 400 or more is referred to as a high molecular weight polyol. Further, a polyol having a number average molecular weight of below 400 is referred to as a low molecular weight polyol.

The number average molecular weight is, for example, calculated by measurement by a GPC method, or by a hydroxyl value and a formulation (average functionality). Preferably, it is calculated by a hydroxyl value and a formulation (average functionality) (hereinafter, the same).

The hydroxyl value is measured in conformity with the description of JIS K 1557-1 (2007). The polyol component contains a high molecular weight polyol as an essential component, and more specifically, contains a polycarbonate polyol having a number average molecular weight of 600 or more and 1200 or less and a polyester polyol having a number average molecular weight of 600 or more and 1200 or less.

Examples of the polycarbonate polyol include crystalline polycarbonate polyols such as a ring-opening polymer of an ethylene carbonate or a phenyl carbonate which uses a low molecular weight polyol as an initiator. Crystallinity indicates solid at 25° C.

An example of the low molecular weight polyol includes a compound (monomer) having two or more hydroxyl groups in a molecule and having a molecular weight of 50 or more and below 400. Specifically, examples of the low molecular weight polyol include polyhydric alcohols such as dihydric alcohols such as C2 to C4 alkanediols including ethylene glycol, propylene glycol, 1,3-propanediol, 1,4-butylene glycol (1,4-butanediol, 1,4-BD), 1,3-butylene glycol, and 1,2-butylene glycol, 1,5-pentanediol, 1,6-hexanediol, neopentyl glycol, 3-methyl-1,5-pentanediol, 2,2,2-trimethylpentanediol, 3,3-dimethylolheptane, alkane (C7 to C20) diol, 1,3- or 1,4-cyclohexanedimethanol and a mixture of these, 1,3- or 1,4-cyclohexanediol and a mixture of these, 1,4-dihydroxy-2-butene, 2,6-dimethyl-1-octene-3,8-diol, bisphenol A and a hydrogenated product thereof, diethylene glycol, triethylene glycol, dipropylene glycol, 1,2-benzenediol, 1,3-benzenediol, and 1,4-benzenediol; trihydric alcohols such as glycerin, trimethylolpropane, and triisopropanolamine; tetrahydric alcohols such as tetramethylolmethane (pentaerythritol) and diglycerine; pentahydric alcohols such as xylitol; hexahydric alcohols such as sorbitol, mannitol, allitol, iditol, dulcitol, altritol, inositol, and dipentaerythritol; heptahydric alcohols such as perseitol: and octahydric alcohols such as sucrose.

Further, an example of the low molecular weight polyol includes a polyoxyalkylene polyol (including a random and/or block copolymer) obtained by subjecting an alkylene oxide having 2 to 3 carbon atoms (ethylene oxide, propylene oxide) to an addition reaction by using the above-described polyhydric alcohol as an initiator so as to have the above-described molecular weight.

These low molecular weight polyols may be used alone or in combination of two or more.

As the low molecular weight polyol, preferably, a dihydric alcohol is used in the application of the initiator of the ring-opening polymerization described above.

A molecular weight of the low molecular weight polyol is, for example, 50 or more, preferably 70 or more, and is below 400, preferably 300 or less.

Further, an example of the polycarbonate polyol includes an amorphous polycarbonate polyol obtained by copolymerizing, for example, the ring-opening polymer with the low molecular weight polyol in addition to the above-described ring-opening polymer. Amorphousness indicates liquid at 25° C.

These polycarbonate polyols may be used alone or in combination of two or more.

A number average molecular weight of the polycarbonate polyol is 600 or more, preferably 700 or more, more preferably 800 or more, further more preferably 900 or more from the viewpoint of demoldability, and is 1200 or less, preferably 1100 or less, more preferably 1000 or less from the viewpoint of moist heat bloom resistance.

By using two or more kinds of polycarbonate polyols in combination, the number average molecular weight of these polycarbonate polyols as a whole can be also adjusted within the above-described range. In such a case, as long as the number average molecular weight of the polycarbonate polyol as a whole is within the above-described range (600 to 1200), each of the polycarbonate polyols to be used in combination may be a polycarbonate polyol having a number average molecular weight of below the above-described lower limit (600), and may be a polycarbonate polyol having a number average molecular weight of above the above-described upper limit (1200).

When two or more kinds of polycarbonate polyols are used in combination, the number average molecular weight of the polycarbonate polyol as a whole is the total sum of a value obtained by multiplying the mole ratio (%) of each polycarbonate polyol used in combination by the number average molecular weight of each polycarbonate polyol, and is calculated by a known method.

Further, an average number of hydroxyl groups of the polycarbonate polyol is, for example, 2 or more, and is, for example, 4 or less, preferably 3 or less, particularly preferably 2.

By using two or more kinds of polycarbonate polyols in combination, the average number of hydroxyl groups of these polycarbonate polyols as a whole can be also adjusted within the above-described range. In such a case, as long as the average number of hydroxyl groups of the polycarbonate polyol as a whole is within the above-described range, each of the polycarbonate polyols to be used in combination may be a polycarbonate polyol having an average number of hydroxyl groups of below the above-described lower limit, and may be a polycarbonate polyol having an average number of hydroxyl groups of above the above-described upper limit.

When two or more kinds of polycarbonate polyols are used in combination, the average number of hydroxyl groups of the polycarbonate polyol as a whole is the total sum of a value obtained by multiplying the mole ratio (%) of each polycarbonate polyol used in combination by the average number of hydroxyl groups of each polycarbonate polyol, and is calculated by a known method.

An example of the polyester polyol includes a polycondensate obtained by reacting a low molecular weight polyol with a polybasic acid under known conditions.

Examples of the low molecular weight polyol include the above-described low molecular weight polyols (for example, dihydric to octahydric alcohols). These may be used alone or in combination of two or more.

As the low molecular weight polyol, preferably, a dihydric alcohol is used, more preferably a 1,4-butylene glycol (1,4-butanediol, 1,4-BD) is used.

Examples of the polybasic acid include saturated aliphatic dicarboxylic acids such as oxalic acid, malonic acid, succinic acid, methylsuccinic acid, glutaric acid, adipic acid, 1,1-dimethyl-1,3-dicarboxypropane, 3-methyl-3-ethylglutaric acid, azelaic acid, and sebacic acid; unsaturated aliphatic dicarboxylic acids such as maleic acid, fumaric acid, and itaconic acid; aromatic dicarboxylic acids such as orthophthalic acid, isophthalic acid, terephthalic acid, toluene dicarboxylic acid, and naphthalene dicarboxylic acid; alicyclic dicarboxylic acids such as hexahydrophthalic acid; other carboxylic acids such as dimer acid, hydrogenated dimer acid, and HET acid and anhydrides derived from these carboxylic acids such as oxalic anhydride, succinic anhydride, maleic anhydride, phthalic anhydride, 2-alkyl (C12 to C18) succinic anhydride, tetrahydrophthalic anhydride, trimellitic anhydride; and furthermore, acid halides derived from these carboxylic acids such as oxalic acid dichloride, adipic acid dichloride, and sebacic acid dichloride. These may be used alone or in combination of two or more.

As the polybasic acid, preferably, a saturated aliphatic dicarboxylic acid is used, more preferably, an adipic acid is used.

Further, an example of the polyester polyol includes a polyester polyol derived from a plant, specifically, a vegetable oil-based polyester polyol obtained by subjecting a hydroxycarboxylic acid such as a hydroxyl group-containing vegetable oil fatty acid (for example, castor oil fatty acid containing ricinoleic acid, hydrogenated castor oil fatty acid containing a 12-hydroxystearic acid, and the like) to a condensation reaction under known conditions by using the above-described low molecular weight polyol as an initiator.

Further, examples of the polyester polyol include lactone-based polyester polyols. The lactone-based polyester polyol can be, for example, obtained by ring-opening polymerization of lactones such as ε-caprolactone, γ-valerolactone, and the like and lactides such as L-lactide, D-lactide, and the like by using the above-described low molecular weight polyol (preferably, a dihydric alcohol) as an initiator.

More specifically, examples of the lactone-based polyester polyol include a polycaprolactone polyol obtained by ring-opening polymerization of a ε-caprolactone by using the above-described low molecular weight polyol (preferably a dihydric alcohol) as an initiator, and a polyvalerolactone polyol obtained by ring-opening polymerization of a γ-valerolactone by using the above-described low molecular weight polyol (preferably a dihydric alcohol) as an initiator, and further examples thereof include those obtained by copolymerization of the above-described dihydric alcohol.

These polyester polyols may be used alone or in combination of two or more.

As the polyester polyol, preferably, a polycondensate of a low molecular weight polyol and a polybasic acid is used alone, or a lactone-based polyester polyol is used alone. Further, as the polycondensate of the low molecular weight polyol and the polybasic acid, preferably, a polycondensate of a 1,4-butylene glycol and an adipic acid (that is, a polybutylene adipate) is used. Further, as the lactone-based polyester polyol, preferably, a polycaprolactone polyol is used. As the polyester polyol, particularly preferably, a polycaprolactone polyol is used.

A number average molecular weight of the polyester polyol is 600 or more, preferably 800 or more, more preferably 900 or more, further more preferably 1000 or more from the viewpoint of demoldability, and is 1200 or less, preferably 1100 or less from the viewpoint of moist heat bloom resistance.

By using two or more kinds of polyester polyols in combination, the number average molecular weight of these polyester polyols as a whole can be also adjusted within the above-described range. In such a case, as long as the number average molecular weight of the polyester polyol as a whole is within the above-described range (600 to 1200), each polyester polyol to be used in combination may be a polyester polyol having a number average molecular weight of below the above-described lower limit (600), and may be a polyester polyol having a number average molecular weight of above the above-described upper limit (1200).

When two or more kinds of polyester polyols are used in combination, the number average molecular weight of the polyester polyol as a whole is the total sum of a value obtained by multiplying the mole ratio (%) of each polyester polyol used in combination by the number average molecular weight of each polyester polyol, and is calculated by a known method.

Further, an average number of hydroxyl groups of the polyester polyol is, for example, 2 or more, and is, for example, 4 or less, preferably 3 or less, particularly preferably 2.

By using two or more kinds of polyester polyols in combination, the average number of hydroxyl groups of these polyester polyols as a whole can be also adjusted within the above-described range. In such a case, as long as the average number of hydroxyl groups of the polyester polyol as a whole is within the above-described range, each of the polyester polyols to be used in combination may be a polyester polyol having an average number of hydroxyl groups of below the above-described lower limit, and may be a polyester polyol having an average number of hydroxyl groups of above the above-described upper limit.

When two or more kinds of polyester polyols are used in combination, the average number of hydroxyl groups of the polyester polyol as a whole is the total sum of a value obtained by multiplying the mole ratio (%) of each polyester polyol used in combination by the average number of hydroxyl groups of each polyester polyol, and is calculated by a known method.

Then, as a mass ratio of the polycarbonate polyol and the polyester polyol, from the viewpoint of achieving both the moist heat bloom resistance and the demoldability, a ratio of the polycarbonate polyol is 3 parts by mass or more, preferably 5 parts by mass or more, more preferably 10 parts by mass or more, further more preferably 15 parts by mass or more, further more preferably 20 parts by mass or more, further more preferably 25 parts by mass or more, and is 40 parts by mass or less, preferably 35 parts by mass or less, more preferably 30 parts by mass or less with respect to 100 parts by mass of the total amount of the polycarbonate polyol and the polyester polyol. Further, a ratio of the polyester polyol is 60 parts by mass or more, preferably 65 parts by mass or more, more preferably 70 parts by mass or more, and is 97 parts by mass or less, preferably 95 parts by mass or less, more preferably 90 parts by mass or less, further more preferably 85 parts by mass or less, further more preferably 80 parts by mass or less, further more preferably 75 parts by mass or less with respect to 100 parts by mass of the total amount of the polycarbonate polyol and the polyester polyol.

Further, if necessary, the polyol component may contain a low molecular weight polyol and a high molecular weight polyol excluding, for example, a polycarbonate polyol and a polyester polyol (hereinafter, the other high molecular weight polyol). The polyol component preferably contains a low molecular weight polyol.

Examples of the low molecular weight polyol include the above-described low molecular weight polyols. These may be used alone or in combination of two or more. As the low molecular weight polyol, preferably, a dihydric alcohol is used, more preferably, a C2 to C4 alkanediol is used, further more preferably, a 1,4-butylene glycol is used.

A content ratio of the low molecular weight polyol is, for example, 0% by mass or more, preferably 5% by mass or more, more preferably 10% by mass or more, further more preferably 15% by mass or more, and is, for example, 30% by mass or less, preferably 25% by mass or less, more preferably 20% by mass or less with respect to the total amount of the polyol component.

The other high molecular weight polyol is an organic compound (polymer) having two or more hydroxyl groups and having a number average molecular weight of 400 or more, preferably 500 or more, and examples thereof include polyether polyols (polyoxyalkylene (2 to 3 carbon atoms) polyols, tetramethylene ether polyols, and the like), polyurethane polyols, epoxy polyols, vegetable oil polyols, polyolefin polyols, acrylic polyols, and vinyl monomer-modified polyols. These may be used alone or in combination of two or more.

A content ratio of the other high molecular weight polyol is, for example, 30% by mass or less, preferably 20% by mass or less, more preferably 10% by mass or less, further more preferably 5% by mass or less, particularly preferably 0% by mass with respect to the total amount of the polyol component.

The polyol component preferably does not contain the other high molecular weight polyol.

In other words, the polyol component preferably consists of a polycarbonate polyol having a number average molecular weight of 600 or more and 1200 or less, a polyester polyol having a number average molecular weight of 600 or more and 1200 or less, and a low molecular weight polyol.

Then, as described in detail later, by reacting the above-described polyisocyanate component with the above-described polyol component, a thermoplastic polyurethane resin can be obtained as a reaction product of these.

In the present invention, a wax is an additive contained in the thermoplastic polyurethane resin composition in order to improve the bloom resistance in the moist heat environment and also to improve the demoldability.

Examples of the wax include olefin-based waxes, fatty acid ester-based waxes, and fatty acid amide-based waxes.

Examples of the olefin-based wax include polyethylene wax, polypropylene wax, polyethylene-polypropylene copolymer wax, paraffin wax, microcrystalline wax, carnava wax, and acid-modified products (acid-modified olefin waxes) of these olefin-based waxes (non-modified waxes). These may be used alone or in combination of two or more.

An example of the fatty acid ester-based wax includes a fatty acid ester which is an esterification reaction product of a higher aliphatic carboxylic acid (for example, caprylic acid, capric acid, lauric acid, myristic acid, palmitic acid, stearic acid, behenic acid, oleic acid, linolic acid, linolenic acid, montanic acid, and the like) and the above-described low molecular weight polyol (for example, dihydric to octahydric alcohols). These may be used alone or in combination of two or more.

Examples of the fatty acid amide-based wax include fatty acid amides such as stearylamide, palmitylamide, oleylamide, methylene-bis stearic acid amide, and ethylene-bis stearic acid amide. These may be used alone or in combination of two or more.

These waxes may be used alone or in combination of two or more.

As the wax, preferably, a polyolefin-based wax, a fatty acid ester-based wax, and a fatty acid amide-based wax are used, more preferably, a polyolefin-based wax and a fatty acid ester-based wax are used, further more preferably, a polyolefin-based wax is used, further more preferably, a non-modified polyolefin wax is used, particularly preferably, a polyethylene-polypropylene copolymer is used.

In other words, the thermoplastic polyurethane resin composition preferably contains at least one kind selected from the group consisting of a polyolefin-based wax, a fatty acid ester-based wax, and a fatty acid amide-based wax.

Also, the wax preferably includes a polyolefin-based wax.

The melt viscosity at 150° C. of the polyolefin-based wax is, for example, 1 mPa·s or more, preferably 5 mPa·s or more, more preferably 10 mPa·s or more, and is, for example, 500 mPa·s or less, preferably 300 mPa·s or more, more preferably 100 mPa·s or less, further more preferably 50 mPa·s or less, particularly preferably 30 mPa·s or less from the viewpoint of improving the moist heat bloom resistance.

Also, the wax preferably includes a fatty acid ester-based wax and/or a fatty acid amide-based wax.

The melt viscosity at 190° C. of the fatty acid ester-based wax and the fatty acid amide-based wax is, for example, 1 mPa·s or more, preferably 5 mPa·s or more, more preferably 10 mPa·s or more, and is, for example, 500 mPa·s or less, preferably 300 mPa·s or more, more preferably 100 mPa·s or less, further more preferably 50 mPa·s or less, particularly preferably 30 mPa·s or less from the viewpoint of improving the moist heat bloom resistance.

The melt viscosity of the wax is measured with a cone plate viscometer in conformity with Examples to be described later.

From the viewpoint of moist heat bloom resistance and demoldability, a content ratio of the wax is, for example, 0.001 parts by mass (phr) or more, preferably 0.005 parts by mass (phr) or more, more preferably 0.01 parts by mass (phr) or more, further more preferably 0.02 parts by mass (phr) or more, further more preferably 0.03 parts by mass (phr) or more, particularly preferably 0.05 parts by mass (phr) or more, and is, for example, 0.5 parts by mass (phr) or less, preferably 0.15 parts by mass (phr) or less, more preferably 0.10 parts by mass (phr) or less, further more preferably 0.08 parts by mass (phr) or less, particularly preferably 0.07 parts by mass (phr) or less with respect to 100 parts by mass of the total amount of the polyisocyanate component and the polyol component (that is, the thermoplastic polyurethane resin).

From the viewpoint of achieving both the moist heat bloom resistance and the demoldability, the wax particularly preferably includes two or more kinds selected from the group consisting of a polyolefin-based wax, a fatty acid ester-based wax, and a fatty acid amide-based wax. That is, particularly preferably, two or more kinds of waxes are used in combination.

In such a case, preferably, a polyolefin-based wax and a fatty acid ester-based wax and/or a fatty acid amide-based wax are used in combination, more preferably, a polyolefin-based wax and a fatty acid amide-based wax are used in combination, particularly preferably, a non-modified polyolefin-based wax and a fatty acid amide-based wax are used in combination.

When the polyolefin-based wax and the fatty acid ester-based wax and/or the fatty acid amide-based wax are used in combination, a ratio of the polyolefin-based wax is, for example, 50 parts by mass or more, preferably 55 parts by mass or more, more preferably 60 parts by mass or more, further more preferably 70 parts by mass or more, and is, for example, 95 parts by mass or less, preferably 90 parts by mass or less, more preferably 85 parts by mass or less, further more preferably 80 parts by mass or less with respect to 100 parts by mass of the total amount of these. Further, a ratio of the fatty acid ester-based wax and/or the fatty acid amide-based wax is, for example, 5 parts by mass or more, preferably 10 parts by mass or more, more preferably 15 parts by mass or more, further more preferably 20 parts by mass or more, and is, for example, 50 parts by mass or less, preferably 45 parts by mass or less, more preferably 40 parts by mass or less, further more preferably 30 parts by mass or less with respect to 100 parts by mass of the total amount of these.

The wax is added at appropriate timing, for example, at the time of production of the thermoplastic polyurethane resin composition to be described later (that is, a reaction of the polyisocyanate component and the polyol component).

More specifically, the wax may be added in advance, for example, to the polyisocyanate component and/or the polyol component before the reaction, may be added simultaneously at the time of mixing of the polyisocyanate component and the polyol component, and furthermore, may be added to a mixture of the polyisocyanate component and the polyol component in the production of the thermoplastic polyurethane resin composition to be described later.

Preferably, the wax is added to the polyol component before the reaction.

Then, in the reaction of the polyisocyanate component and the polyol component, by adding the wax at appropriate timing, the thermoplastic polyurethane resin composition containing the thermoplastic polyurethane resin and the wax is obtained.

In order to react the above-described polyisocyanate component with the above-described polyol component, for example, a known method such as a one-shot method and a prepolymer method is used.

Specifically, in the one-shot method, the polyisocyanate component and the polyol component are blended at a predetermined ratio.

As a mixing ratio, an equivalent ratio (isocyanate group/hydroxyl group) of an isocyanate group in the polyisocyanate component with respect to a hydroxyl group in the polyol component is, for example, 0.750 or more, preferably 0.900 or more, more preferably 0.950 or more, further more preferably 0.960 or more, particularly preferably 0.970 or more, and is, for example, 1.30 or less, preferably 1.10 or less, more preferably 1.00 or less, further more preferably below 1.00, further more preferably 0.999 or less, further more preferably 0.995 or less, particularly preferably 0.990 or less.

Then, in this method, the polyisocyanate component and the polyol component (preferably, including the high molecular weight polyol and the low molecular weight polyol) are, for example, reacted by a polymerization method such as bulk polymerization and solution polymerization.

In the bulk polymerization, for example, the polyisocyanate component and the polyol component are reacted under a nitrogen stream at a reaction temperature of, for example, 50° C. or more, and for example, 250° C. or less, preferably 200° C. or less for, for example, 0.5 hours or more, and for example, 22 hours or less.

In the solution polymerization, the polyisocyanate component and the polyol component are added to the organic solvent to be reacted at a reaction temperature of, for example, 50° C. or more, and for example, 120° C. or less, preferably 100° C. or less for, for example, 0.5 hours or more, and for example, 15 hours or less.

Examples of the organic solvent include ketones such as acetone, methyl ethyl ketone, methyl isobutyl ketone, and cyclohexanone; nitriles such as acetonitrile; alkyl esters such as methyl acetate, ethyl acetate, butyl acetate, and isobutyl acetate; aliphatic hydrocarbons such as n-hexane, n-heptane, and octane; alicyclic hydrocarbons such as cyclohexane and methylcyclohexane; aromatic hydrocarbons such as toluene, xylene, and ethylbenzene; glycol ether esters such as methyl cellosolve acetate, ethyl cellosolve acetate, methyl carbitol acetate, ethyl carbitol acetate, ethylene glycol ethyl ether acetate, propylene glycol methyl ether acetate, 3-methyl-3-methoxybutyl acetate, and ethyl-3-ethoxypropionate; ethers such as diethyl eter, tetrahydrofuran, and dioxane; halogenated aliphatic hydrocarbons such as methyl chloride, methylene chloride, chloroform, carbon tetrachloride, methyl bromide, methylene iodide, and dichloroethane; and polar aprotones such as N-methylpyrrolidone, dimethylformamide, N,N′-dimethylacetamide, dimethyl sulfoxide, and hexamethylphosphonylamide.

In addition, in the above-described polymerization reaction, if necessary, for example, a known urethanization catalyst such as amines and an organic metal compound can be added.

Examples of the amines include tertiary amines such as triethylamine, triethylenediamine, bis-(2-dimethylaminoethyl)ether, and N-methylmorpholine; quaternary ammonium salts such as tetraethylhydroxylammonium; and imidazoles such as imidazole and 2-ethyl-4-methylimidazole.

Examples of the organic metal compound include organic tin compounds such as tin acetate, tin octylate, tin oleate, tin laurate, dibutyltin diacetate, dimethyltin dilaurate, dibutyltin dilaurate, dibutyltin dimercaptide, dibutyltin maleate, dibutyltin dineodecanoate, dioctyltin dimercaptide, dioctyltin dilaurylate, and dibutyltin dichloride; organic lead compounds such as lead octanoate and lead naphthenate; organic nickel compounds such as nickel naphthenate; organic cobalt compounds such as cobalt naphthenate; organic copper compounds such as copper octenate; and organic bismuth compounds such as bismuth octanoate (bismuth octylate) and bismuth neodecanoate, and preferably, a tin octylate and a bismuth octylate are used.

Furthermore, examples of the urethanization catalyst include potassium salts such as potassium carbonate, potassium acetate, and potassium octylate.

These urethanization catalysts may be used alone or in combination of two or more.

An addition ratio of the urethanization catalyst is, for example, 0.001 parts by mass or more, preferably 0.01 parts by mass or more, and is, for example, 1 part by mass or less, preferably 0.5 parts by mass or less with respect to 10000 parts by mass of the total amount of the polyisocyanate component and the polyol component.

In the above-described polymerization reaction, an unreacted polyisocyanate component or an organic solvent, if used, can be, for example, removed by a known removal method such as distillation and extraction.

In addition, in the prepolymer method, first, the polyisocyanate component and the high molecular weight polyol are reacted by a polymerization method such as bulk polymerization and solution polymerization described above, so that an isocyanate group-terminated polyurethane prepolymer is synthesized.

As a mixing ratio, an equivalent ratio (isocyanate group/hydroxyl group) of an isocyanate group in the polyisocyanate component to a hydroxyl group in the high molecular weight polyol is, for example, 2.0 or more, preferably 2.5 or more, and is, for example, 20 or less, preferably 15 or less, more preferably 10 or less, further more preferably 8 or less.

In the bulk polymerization, for example, the polyisocyanate component and the high molecular weight polyol are reacted under a nitrogen stream at a reaction temperature of, for example, 50° C. or more, and for example, 250° C. or less, preferably 200° C. or less for, for example, 0.5 hours or more, and for example, 15 hours or less.

In the solution polymerization, the polyisocyanate component and the high molecular weight polyol are added to the organic solvent to be reacted at a reaction temperature of, for example, 50° C. or more, and for example, 120° C. or less, preferably 100° C. or less for, for example, 0.5 hours or more, and for example, 15 hours or less.

Then, in this method, the isocyanate group-terminated polyurethane prepolymer obtained by the description above and the low molecular weight polyol as a chain extender are reacted to obtain a reaction product of the polyisocyanate component and the polyol component (chain extension step).

As a mixing ratio, an equivalence ratio (isocyanate group/hydroxyl group) of an isocyanate group in the isocyanate group-terminated polyurethane prepolymer with respect to a hydroxyl group in the low molecular weight polyol is, for example, 0.750 or more, preferably 0.900 or more, more preferably 0.950 or more, further more preferably 0.960 or more, particularly preferably 0.970 or more, and is, for example, 1.30 or less, preferably 1.10 or less, more preferably 1.00 or less, further more preferably below 1.00, further more preferably 0.999 or less, further more preferably 0.995 or less, particularly preferably 0.990 or less.

A reaction temperature is, for example, room temperature or more, preferably 50° C. or more, and is, for example, 200° C. or less, preferably 150° C. or less, and the reaction time is, for example, 5 minutes or more, preferably 1 hour or more, and is, for example, 72 hours or less, preferably 48 hours or less.

In addition, in the above-described polymerization reaction (prepolymer step and/or chain extension step), if necessary, for example, the above-described urethanization catalyst can be added.

In addition, in the above-described polymerization reaction, an unreacted polyisocyanate component or an organic solvent, if used, can be, for example, removed by a known removal method such as distillation and extraction.

Then, as described above, by reacting the polyisocyanate component with the polyol component, a thermoplastic polyurethane resin is obtained as a reaction product.

Furthermore, by reacting the polyisocyanate component with the polyol component in the presence of the wax, a thermoplastic polyurethane resin composition containing the thermoplastic polyurethane resin and the wax is obtained.

The obtained thermoplastic polyurethane resin composition is subjected to heat treatment if necessary.

In the heat treatment, the thermoplastic polyurethane resin composition obtained in the above-described reaction is subjected to heat treatment by being left to stand at a predetermined heat treatment temperature for a predetermined heat treatment period, and then, dried if necessary.

A heat treatment temperature is, for example, 50° C. or more, preferably 60° C. or more, more preferably 70° C. or more, and is, for example, 100° C. or less, preferably 90° C. or less.

When the heat treatment temperature is within the above-described range, it is possible to achieve the molding stability (demoldability), the moist heat bloom resistance, and the discoloration resistance in combination.

The heat treatment period is, for example, 3 days or more, preferably 4 days or more, more preferably 5 days or more, further more preferably 6 days or more, and is, for example, 10 days or less, preferably 9 days or less, more preferably 8 days or less.

When the heat treatment period is within the above-described range, it is possible to achieve the molding stability (demoldability), the moist heat bloom resistance, and the discoloration resistance in combination.

Thus, a thermoplastic polyurethane resin composition subjected to the heat treatment can be obtained.

An additive excluding the wax (hereinafter, the other additive) may be added to the thermoplastic polyurethane resin composition if necessary. Examples of the other additive include antioxidants, heat resistance stabilizers, ultraviolet absorbers, light resistance stabilizers, hydrolysis inhibitors (carbodiimide compounds and the like), furthermore, plasticizers, anti-blocking agents, release agents, pigments, dyes (blueing agents and the like), lubricants (fatty acid amide-based lubricants), fillers, rust inhibitors, and fillers. These additives may be added in advance to the polyisocyanate component and/or the polyol component which are/is a raw material of the thermoplastic polyurethane resin composition, may be added at the time of mixing of the polyisocyanate component and the polyol component, and furthermore, may be added to a mixture of the polyisocyanate component and the polyol component.

The antioxidant is not particularly limited, and examples thereof include known antioxidants (for example, described in a catalog manufactured by BASF Japan Ltd.), and more specifically, examples thereof include phenol-based antioxidants and hindered phenol-based antioxidants.

The heat resistance stabilizer is not particularly limited, and examples thereof include known heat resistance stabilizers (for example, described in a catalog manufactured by BASF Japan Ltd.), and more specifically, examples thereof include phosphorus-based processing heat stabilizers, lactone-based processing heat stabilizers, and sulfur-based processing heat stabilizers.

The ultraviolet absorber is not particularly limited, and examples thereof include known ultraviolet absorbers (for example, described in a catalog manufactured by BASF Japan Ltd.), and more specifically, examples thereof include benzotriazole-based ultraviolet absorbers, triazine-based ultraviolet absorbers, and benzophenone-based ultraviolet absorbers.

The light resistance stabilizer is not particularly limited, and examples thereof include known light resistance stabilizers (for example, described in a catalog manufactured by ADEKA CORPORATION), and more specifically, examples thereof include benzoate-based light stabilizers and hindered amine-based light stabilizers.

Each of the additives is added to the thermoplastic polyurethane resin composition at a ratio of, for example, 0.001% by mass or more, preferably 0.01% by mass or more, and for example, 3.0% by mass or less, preferably 2.0% by mass or less with respect to the thermoplastic polyurethane resin composition.

Then, such a thermoplastic polyurethane resin composition contains a reaction product (thermoplastic polyurethane resin) of the polyisocyanate component and the polyol component, and the wax; the polyisocyanate component contains the highly symmetrical polyisocyanate; and the polyol component contains the polycarbonate polyol having a predetermined molecular weight and the polyester polyol having a predetermined molecular weight. Furthermore, in the above-described thermoplastic polyurethane resin composition, the ratio of the polyester polyol is adjusted so as to be excessive with respect to that of the polycarbonate polyol. Therefore, the thermoplastic polyurethane resin composition has excellent bloom resistance in the moist heat environment and demoldability.

In other words, the polyisocyanate component contains the highly symmetrical polyisocyanate, so that the crystallinity of the thermoplastic polyurethane resin increases. Therefore, for example, productivity of the thermoplastic polyurethane resin composition in cast molding tends to be improved.

However, in such a case, it has been found that bloom tends to occur in an obtained molded article by an increase in the crystallinity. Also, the bloom has been conventionally caused by the wax contained in the molded article.

On the other hand, in the present invention, it has been found that in a case where the polyisocyanate component contains a polyisocyanate having the above-described specific structure, by allowing the polyol component to contain a polycarbonate polyol having a predetermined molecular weight and a polyester polyol having a predetermined molecular weight at the above-described specific ratio, and a wax to be added, the occurrence of bloom can be suppressed.

Furthermore, in the present invention, when the polyol component contains the low molecular weight polyol, it is possible to improve the mechanical properties of the thermoplastic polyurethane resin composition.

In other words, when the polyol component contains the low molecular weight polyol, a reaction product (thermoplastic polyurethane resin) of the polyisocyanate component and the polyol component contains a hard segment formed by a reaction of the polyisocyanate component and the low molecular weight polyol, and a soft segment formed by a reaction of the polyisocyanate component and the high molecular weight polyol.

By adjusting the content ratio (hard segment concentration) of the hard segment, it is possible to improve the mechanical properties of the thermoplastic polyurethane resin.

The hard segment concentration of the thermoplastic polyurethane resin is, for example, 3% by mass or more, preferably 5% by mass or more, more preferably 8% by mass or more, and is, for example, 55% by mass or less, preferably 50% by mass or less, more preferably 45% by mass or less, further more preferably 40% by mass or less from the viewpoint of mechanical properties.

The hard segment concentration can be calculated by a known method. For example, when a prepolymer method is used, the hard segment concentration is calculated from a mixing formulation (charging) of each component by the following formula.

[chain extender (g)+(chain extender (g)/ molecular weight of chain extender (g/mol))×average molecular weight of polyisocyanate component (g/mol)]÷(polyisocyanate component (g)+polyol component (g))×100

Further, the urethane group concentration of the thermoplastic polyurethane resin is, for example, 0.1 mmol/g or more, preferably 1 mmol/g or more, and is, for example, 20 mmol/g or less, preferably 10 mmol/g or less.

The urethane group concentration can be calculated from a charging ratio of raw material components by a known method.

In addition, from the viewpoint of bloom resistance and demoldability, a temperature at which the viscosity of the thermoplastic polyurethane resin composition is 2000 Pa·s is, for example, 170° C. or more, preferably 180° C. or more, more preferably 185° C. or more, further more preferably 190° C. or more, particularly preferably 195° C. or more, and is, for example, 250° C. or less, preferably 230° C. or less, more preferably 225° C. or less, further more preferably 220° C. or less, particularly preferably 210° C. or less.

The viscosity of the thermoplastic polyurethane resin composition is measured by a Koka-type flow tester in conformity with Examples to be described later.

Further, the present invention includes a molded article containing the above-described thermoplastic polyurethane resin composition. The molded article is molded from the thermoplastic polyurethane resin composition.

The molded article can be, for example, obtained by molding the above-described thermoplastic polyurethane resin composition into various shapes such as pellet-shape, plate-shape, fiber-shape, strand-shape, film-shape, sheet-shape, pipe-shape, hollow-shape, box-shape, and the like by a known molding method such as thermal compression molding and cast molding using a specific mold, extrusion molding using a sheet winding apparatus, and a heat molding processing method such as melt spinning molding.

More specifically, for example, the above-described thermoplastic polyurethane resin composition can be obtained by being molded into a pellet shape, and furthermore, a molded article having an arbitrary shape can be obtained by molding a pellet-shaped thermoplastic polyurethane resin composition by, for example, a known molding method such as extrusion molding and cast molding.

Further, if necessary, the resulting molded article can be also subjected to heat treatment (annealed).

A heat treatment temperature is, for example, 50° C. or more, preferably 60° C. or more, more preferably 70° C. or more, and is, for example, 100° C. or less, preferably 90° C. or less.

The heat treatment time is, for example, 1 hour or more, preferably 12 hours or more, and is, for example, 7 days or less, preferably 3 days or less.

Further, if necessary, the resulting molded article can be also matured at room temperature for 1 to 10 days.

Then, since the obtained molded article contains the above-described thermoplastic polyurethane resin composition, it has excellent bloom resistance in the moist heat environment and demoldability.

In the description above, the thermoplastic polyurethane resin composition and the molded article thereof are illustrated. Alternatively, the polyurethane resin composition and the molded article thereof of the present invention may be also, for example, a thermosetting polyurethane resin composition and a molded article thereof.

In the production of the thermosetting polyurethane resin composition, for example, the polyisocyanate component and the polyol component described above are reacted with a known cross-linking polyol (trihydric or more low molecular weight polyol), aromatic diamine, and the like, and the mixture is subjected to cast molding, and if necessary, heat treatment. Thus, the thermosetting polyurethane resin is obtained.

Further, in the production of the thermosetting polyurethane resin, by adding a wax at appropriate timing, the thermosetting polyurethane resin composition containing the thermosetting polyurethane resin and the wax is obtained.

When the polyurethane resin composition of the present invention is the thermosetting polyurethane resin composition, the thermoplastic polyurethane resin in the above-described description can be replaced with the thermosetting polyurethane resin, and the thermoplastic polyurethane resin composition can be replaced with the thermosetting polyurethane resin composition.

Then, the molded article consisting of the thermosetting polyurethane resin composition and the thermosetting polyurethane resin composition also has excellent moist heat bloom resistance and demoldability in combination.

Therefore, the molded article made of the thermosetting polyurethane resin composition can be preferably used in the field requiring various properties described above, and particularly, can be preferably used as a cover for a smart device.

More specifically, the smart devices are multifunctional information processing terminals, and examples thereof include smartphones, tablet computers (tablet PCs), and slate computers (slate PCs).

Such smart devices are usually formed to have detachable resin covers, and such covers require the molding stability (demoldability) and moisture heat bloom resistance (furthermore, if necessary, discoloration resistance). Therefore, the molded article of the polyurethane resin composition described above is preferably used as a cover for a smart device.

In addition to the above-described application, the molded article is widely available industrially, and specifically, examples thereof include transparent hard plastics, coating materials, pressure-sensitive adhesives, adhesives, water-proofing materials, potting agents, inks, binders, films (for example, films such as paint protection films and chipping films), sheets, bands (for example, bands such as watch bands, and for example, belts such as automobile transmission belts and various industrial conveyance belts (conveyor belts)), tubes (for example, in addition to components such as medical tubes and catheters, tubes such as air tubes, hydraulic tubes, and electric wire tubes, and for example, hoses such as fire hoses), blades, speakers, sensors, high brightness LED sealing materials, organic EL members, solar power generation members, robot members, android member, wearable members, clothing supplies, sanitary supplies, cosmetics supplies, food packaging members, sports supplies, leisure supplies, medical supplies, nursing care supplies, residential members, acoustic members, lighting members, chandeliers, outside lights, sealing materials, sealing members, corks, packings, damping-vibration isolation-seismic base isolation members, sound insulation members, commodities, sundries, cushions, beddings, stress absorbing materials, stress relivers, interior and exterior components of automobiles, railroad members, aircraft members, optical members, members for OA equipment, protection members for sundries surfaces, semiconductor sealing materials, self-repairing materials, health appliances, spectacle lenses, toys, cable sheaths, wire harnesses, electrical telegraph cables, automobile wires, computer wires, industrial products such as curl cords, nursing care supplies such as sheets and films, sports supplies, leisure supplies, various sundries, damping-seismic base isolation materials, shock absorbers, optical materials, films such as light guide films, automobile components, surface protective sheets, decorative sheets, transfer sheets, tape members such as semiconductor protective tapes, golf ball members, strings for tennis rackets, agricultural films, wallpapers, antifogging agents, nonwoven fabrics, furniture items such as mattresses and sofas, clothing items such as brassieres and shoulder pads, medical supplies such as cushioning materials for paper diapers, napkins, and medical tapes, sanitary products such as cosmetics, facial puffs, and pillows, shoe items such as shoe soles (outsoles), midsoles, and cover materials, furthermore, body pressure dispersion products such as pads and cushions for vehicles, members that come into contact with hands such as door trims, instrument panels, and gear knobs, heat insulating materials for electric refrigerators and buildings, impact absorbers such as shock absorbers, fillers, vehicle handles, vehicle articles such as automobile interior members and automobile exterior members, and semiconductor manufacturing articles such as chemical mechanical polishing (CMP) pads.

Furthermore, the above-described molded article is preferably used in applications requiring reversibility and wear resistance due to repeated expansion and shrinkage, compressive deformation, and the like. Examples thereof include coating materials (coating materials such as films, sheets, belts, wires, electric wires, rotary equipment made of metal, wheels, and drills), yarns and fibers (yarns and composite fibers used in tubes, tights, spats, sports clothes, swimming clothes, and the like), extrusion molding applications (extrusion molding applications such as guts and its convergence materials for tennis, badminton, and the like), slush molded articles in powder shapes by micropelletization and the like, artificial leather, skins, sheets, coating rolls (coating rolls of steel and the like), sealants, rollers, gears, covers or core materials for balls and bats (covers or core materials for golf balls, basketballs, tennis balls, volleyballs, softballs, and bats (these may be in a form of foam-molded polyurethane resin compositions)), mats, skiing equipment, boots, tennis supplies, grips (grips for golf clubs and motorcycles), rack boots, wipers, seat cushioning members, films for nursing care equipment, 3D printer molded articles, fiber reinforced materials (reinforced materials of fibers such as carbon fibers, lignin, kenaf, nanocellulose fibers, glass fibers, and the like), safety goggles, sunglasses, eyeglass frames, ski goggles, swimming goggles, contact lenses, gas assisted foam molded articles, shock absorbers, CMP polishing pads, dampers, bearings, dust covers, cutting valves, chipping rolls, high-speed rotating rollers, tires, watches, and wearable bands.

### EXAMPLES

Next, the present invention is further described based on Production Examples, Synthesis Examples, Examples, and Comparative Examples. The present invention is however not limited by these. All designations of “part” or “parts” and “%” mean part or parts by mass and % by mass, respectively, unless otherwise particularly specified. The specific numerical values in mixing ratio (content ratio), property value, and parameter used in the following description can be replaced with upper limit values (numerical values defined as “or less” or “below”) or lower limit values (numerical values defined as “or more” or “above”) of corresponding numerical values in mixing ratio (content ratio), property value, and parameter described in the above-described “DESCRIPTION OF EMBODIMENTS”.

1) Raw Materials

<Polyisocyanate Component (a)>

1,4-H₆XDI: 1,4-bis(isocyanatomethyl)cyclohexane synthesized in the method described in Production Example 3 of International Publication WO2019/069802, trans-isomer of 86 mol %

1,3-H₆XDI: 1,3-bis(isocyanatomethyl)cyclohexane, trade name: TAKENATE 600, manufactured by Mitsui Chemicals, Inc.

4,4′-MDI: 4,4′-diphenylmethane diisocyanate, trade name: COSMONATE PH, manufactured by Mitsui Chemicals & SKC Polyurethanes Inc.

IPDI: isophorone diisocyanate, manufactured by Mitsui Chemicals, Inc.

<Polyol Component (b)>

Polycarbonate Polyol (b1)

(b1-1) PCD #500 (number average molecular weight of 500): polycarbonate polyol, trade name: ETERNACOL UH-50, hydroxyl value=224.4 mgKOH/g, manufactured by UBE INDUSTRIES, LTD.

(b1-2) PCD #1000 (number average molecular weight of 1000): polycarbonate polyol, trade name: ETERNACOL UH-100, hydroxyl value=112.2 mgKOH/g, manufactured by UBE INDUSTRIES, LTD.

(b1-3) PCD #2000 (number average molecular weight of 2000): polycarbonate polyol, trade name: ETERNACOL UH-200, hydroxyl value=56.1 mgKOH/g, manufactured by UBE INDUSTRIES, LTD.

Polycaprolactone Polyol (b2)

(b2-1) PCL #500 (number average molecular weight of 500): polycaprolactone polyol, trade name: PLACCEL205U, hydroxyl value=224.4 mgKOH/g, manufactured by Daicel Corporation

(b2-2) PCL #800 (number average molecular weight of 800): polycaprolactone polyol, trade name: PLACCEL208, hydroxyl value=140.3 mgKOH/g, manufactured by Daicel Corporation

(b2-3) PCL #1000 (number average molecular weight of 1000): polycaprolactone polyol, trade name: PLACCEL210N, hydroxyl value=112.2 mgKOH/g, manufactured by Daicel Corporation

(b2-4) PCL #2000 (number average molecular weight of 2000): polycaprolactone polyol, trade name: PLACCEL220N, hydroxyl value=56.1 mgKOH/g, manufactured by Daicel Corporation

Polybutylene Adipate (b3)

(b3-1) PBA #500 (number average molecular weight of 500): polybutylene adipate synthesized by the method described in Production Example 1, hydroxyl value=224.4 mgKOH/g

(b3-2) PBA #600 (number average molecular weight of 600): polybutylene adipate synthesized by the method described in Production Example 2, hydroxyl value=187.0 mgKOH/g

(b3-3) PBA #1000 (number average molecular weight of 1000): polybutylene adipate, trade name: TAKELAC U-2410, hydroxyl value=112.2 mgKOH/g, manufactured by Mitsui Chemicals, Inc.

(b3-4) PBA #1200 (number average molecular weight of 1200): polybutylene adipate synthesized by the method described in Production Example 3, hydroxyl value=93.5 mgKOH/g

(b3-5) PBA #1500 (number average molecular weight of 1500): polybutylene adipate synthesized by the method described in Production Example 4, hydroxyl value=74.8 mgKOH/g

Polytetramethylene Ether Glycol (b4)

(b4-1) PTG #1000 (number average molecular weight of 1000): polytetramethylene ether glycol (PTMEG), trade name: PTG1000, hydroxyl value=112.2 mgKOH/g, manufactured by Hodogaya Chemical Co., Ltd.

<Low Molecular Weight Polyol (b′)>

(b′-1) 1,4-BD: 1,4-butanediol, manufactured by Mitsubishi Chemical Corporation

<Wax (c)>

(c-1) olefin wax 1: polyethylene-polypropylene copolymer wax synthesized by the method described in Synthesis Example 1 to be described later, melt viscosity (150° C.) of 11 mPa·s

(c-2) olefin wax 2: polyethylene-polypropylene copolymer wax synthesized by the method described in Synthesis Example 2 to be described later, melt viscosity (150° C.) of 79 mPa·s

(c-3) olefin wax 3: polyethylene-polypropylene copolymer wax synthesized by the method described in Synthesis Example 3 to be described later, melt viscosity (150° C.) of 285 mPa·s

(c-4) acid-modified olefin wax: maleic anhydride modified product of polyethylene-polypropylene copolymer wax synthesized by the method described in Synthesis Example 4 to be described later, melt viscosity (150° C.) of 86 mPa·s

(c-5) fatty acid ester: fatty acid ester-based wax, trade name: LICOLUB WE4 (montanate ester), manufactured by Clariant Japan K.K., melt viscosity (190° C.) of 16 mPa·s

(c-6) fatty acid amide 1: fatty acid amide-based wax, trade name: Light Amide WH510K, manufactured by KYOEISHA CHEMICAL CO., LTD., melt viscosity (190° C.) of 14 mPa·s

(c-7) fatty acid amide 2: fatty acid amide-based wax, trade name: KAO WAX EB-P (ethylene-bis stearic acid amide), manufactured by Kao Corporation, melt viscosity (190° C.) of 3 mPa·s

(c-8) fatty acid amide 3: fatty acid amide-based wax, trade name: AMX-6091, manufactured by KYOEISHA CHEMICAL CO., LTD., melt viscosity (190° C.) of 55 mPa·s

<Urethanization Catalyst>

Tin-based catalyst: tin (11) octylate, trade name: STANOCT, manufactured by API CORPORATION

<Catalyst Diluent>

Diisononyl adipate: trade name: DINA, manufactured by DAIHACHI CHEMICAL INDUSTRY CO., LTD.

<Stabilizer>

Antioxidant: hindered phenol compound, trade name: Irganox 245, manufactured by BASF Japan Ltd.

Ultraviolet absorber: benzotriazole compound, trade name: Tinuvin 234, manufactured by BASF Japan Ltd.

Light resistance stabilizer: hindered amine compound, trade name: LA-72, manufactured by ADEKA CORPORATION

Hydrolysis inhibitor: carbodiimide compound, trade name: Stabaxol I-LF, manufactured by LANXESS AG

<Dye>

Anthraquinone-based blueing agent: trade name: Plast Blue 8514, manufactured by ARIMOTO CHEMICAL CO., LTD.

2) Measurement Method

(1) Number Average Molecular Weight

A number average molecular weight was calculated based on a hydroxyl value and an average functionality in accordance with the following formula. The average functionality was calculated from a raw material formulation. In addition, the hydroxyl value was measured in conformity with the description of JIS K 1557-1 (2007).

Number average molecular weight=56100×Average functionality/Average hydroxyl value

(2) Viscosity

The wax was melted by heating at 150° C. or 190° C., and the viscosity thereof was measured by the following method.

That is, the melt viscosity at 150° C. or 190° C. was measured using a cone plate viscometer (model number: CV-1S) manufactured by TOAKOUGYO CO., LTD.

In the measurement, a 10-pores cone was used, and the number of rotations of the viscometer was set at 750 rpm.

(3) Hard Segment Concentration

The hard segment concentration was calculated from a mixing formulation (charging) of each component by the following formula.

[chain extender (g)+(chain extender (g)/molecular weight of chain extender (g/mol))×average molecular weight of polyisocyanate component (g/mol)]+(polyisocyanate component (g)+polyol component (g))×100

3) Production of Polybutylene Adipate

### Production Example 1

A four-neck flask equipped with a thermometer, a stirring device, and a Liebig condenser was charged with 2992 g (20.5 mol) of an adipic acid and 2815 g (31.2 mol) of a 1,4-butanediol, and a temperature of the mixture was increased to 180° C., and the temperature thereof was increased to 220° C., while a polycondensation reaction was processed under a nitrogen stream. When the acid value reached 15 mgKOH/g, STANOCT as a catalyst was added thereto and the polycondensation reaction was continued at the same temperature until the acid value reached below 1 mgKOH/g. Thereafter, the resulting mixture was cooled to obtain a polybutylene adipate having a number average molecular weight of 500.

### Production Example 2

A polybutylene adipate having a number average molecular weight of 600 was obtained in the same manner as in Production Example 1, except that 3101 g (21.2 mol) of an adipic acid and 2743 g (30.4 mol) of a 1,4-butanediol were reacted for 12 hours.

### Production Example 3

A polybutylene adipate having a number average molecular weight of 1200 was obtained in the same manner as in Production Example 1, except that 3375 g (23.1 mol) of an adipic acid and 2567 g (28.5 mol) of a 1,4-butanediol were reacted for 16 hours.

### Production Example 4

A polybutylene adipate having a number average molecular weight of 1500 was obtained in the same manner as in Production Example 1, except that 3430 g (23.5 mol) of an adipic acid and 2536 g (28.1 mol) of a 1,4-butanediol were reacted for 18 hours.

4) Synthesis of Wax

### Synthesis Example 1 (Synthesis of Olefin Wax 1)

An ethylene-propylene copolymer was obtained in the method described in Production Example 1 of Japanese Unexamined Patent Publication No. 2017-78100. This was referred to as an olefin wax 1.

### Synthesis Example 2 (Synthesis of Olefin Wax 2)

An ethylene-propylene copolymer was obtained in the same manner as in Production Example 1 of Japanese Unexamined Patent Publication No. 2017-78100, except that a charging amount of hydrogen was changed to 18 kg/cm² (gauge pressure) in Production Example 1 of Japanese Unexamined Patent Publication No. 2017-78100. This was referred to as an olefin wax 2.

### Synthesis Example 3 (Synthesis of Olefin Wax 3)

An ethylene-propylene copolymer was obtained in the same manner as in Production Example 1 of Japanese Unexamined Patent Publication No. 2017-78100, except that a charging amount of hexane was changed to 885 ml, a charging amount of propylene was changed to 115 ml, and a charging amount of hydrogen was changed to 15 kg/cm² (gauge pressure) in Production Example 1 of Japanese Unexamined Patent Publication No. 2017-78100. This was referred to as an olefin wax 3.

### Synthesis Example 4 (Synthesis of Acid-Modified Olefin Wax)

A reaction vessel made of glass was charged with 500 g of the ethylene-propylene copolymer of Production Example 1 of Japanese Unexamined Patent Publication No. 2017-78100 to be melted at 160° C. under a nitrogen atmosphere.

Then, 30 g of a maleic anhydride and 3 g of a di-t-butylperoxide (DTBPO) were continuously fed into the above-described reaction vessel (temperature of 160° C.) over 5 hours.

Thereafter, the mixture was further subjected to a heating reaction for 1 hour, then, subjected to a degassing treatment in the 10 mmHg vacuum in a melted state for 0.5 hours to remove a volatile component, and then, cooled to obtain an acid-modified product of an ethylene-propylene copolymer. This was referred to as an acid-modified olefin wax.

5) Production of Polyurethane Resin Composition and Molded Article

### Example 1

(1) Production of Polyurethane Resin Composition

A high molecular weight polyol (polycarbonate polyol and polyester polyol) which was temperature-controlled to 80° C. in advance was weighed at the ratio described in Table 1.

Then, Stabaxol I-LF (trade name, hydrolysis inhibitor, manufactured by LANXESS AG) was added to the high molecular weight polyol at a ratio of 0.1 parts by mass with respect to 100 parts by mass of the polyester polyol.

The resulting mixture was then stirred in an oil bath at 80° C. under a nitrogen atmosphere for 1 hour with a high-speed stirring disperser (500 to 1500 rpm).

Next, the wax and the additives were added to the high molecular weight polyol.

More specifically, the olefin wax 1 was added to the high molecular weight polyol so that a ratio of the olefin wax 1 was 0.05 parts by mass (phr) with respect to 100 parts by mass of the total amount of the polyisocyanate component and the polyol component (high molecular weight polyol and low molecular weight polyol).

Further, each additive was added to the high molecular weight polyol so as to have 0.3 parts by mass of Irganox 245 (manufactured by BASF Japan Ltd., heat resistance stabilizer), 0.05 parts by mass of Tinuvin 234 (manufactured by BASF Japan Ltd., ultraviolet absorber), and 0.1 parts by mass of ADK STAB LA-72 (manufactured by ADEKA CORPORATION, HALS) with respect to 100 parts by mass of the total amount of the polyisocyanate component and the polyol component (high molecular weight polyol and low molecular weight polyol).

Further, Plast Blue 8514 which was diluted in advance to 0.5% by mass by DINA (manufactured by DAIHACHI CHEMICAL INDUSTRY CO., LTD.) was added to the above-described mixture so that a ratio of Plast Blue 8514 was 0.5 ppm with respect to the polyurethane resin composition.

Next, the polyisocyanate component (a) was added to the above-described mixture in the formulation shown in Table 1.

In addition, a tin octylate (catalyst, trade name: STANOCT, manufactured by API CORPORATION) which was diluted in advance to 4% by mass by DINA (manufactured by DAIHACHI CHEMICAL INDUSTRY CO., LTD.) was added so that a catalyst amount was 5 ppm with respect to the polyurethane resin composition.

Next, the obtained mixture was stirred and mixed in an oil bath at 80° C. for 3 minutes with a high-speed stirring disperser (500 to 1500 rpm).

Then, 1,4-BD (low molecular weight polyol) which was weighed and temperature-controlled to 80° C. in advance was added to the liquid mixture, and the liquid mixture was stirred and mixed for 3 to 10 minutes under stirring at 500 to 1500 rpm using a high-speed stirring disperser.

Then, the liquid mixture was poured into a vat made of Teflon (registered trademark) which was temperature-controlled to 150° C. in advance, the mixture was reacted at 150° C. for 2 hours, and then, the reaction was continued for 20 hours by lowering the temperature to 100° C. to obtain a polyurethane resin composition (primary product) containing the polyurethane resin and the wax. The urethane group concentration of the polyurethane resin calculated from a charging ratio is shown in Table 1.

Production of Pellet

The primary product of the polyurethane resin composition was removed from the vat, cut into a dice shape with a bale cutter, and the dice-shaped resin was pulverized with a pulverizer to obtain pulverized pellets. The pulverized pellets were then subjected to heat treatment (matured, aged) in an oven at 80° C. for 7 days, and dried under vacuum decompression at 23° C. for 12 hours.

Thereafter, strands were extruded and cut from the obtained pulverized pellets using a single-axis extruder (model: SZW40-28MG, manufactured by TECHNOVEL CORPORATION) at a screw number of rotations of 30 rpm and a cylinder temperature within a range of 170 to 270° C., so that pellets of the polyurethane resin composition were obtained.

Production of Molded Article

The pellets of the polyurethane resin composition were dried in advance under vacuum decompression at 80° C. for 12 hours. Then, by using a cast molding machine (model: SE-180DU-C510, manufactured by Sumitomo Heavy Industries, Ltd.), the pellets were cast molded under the following conditions: measurement number of rotations of 100 rpm, barrel temperature of 170 to 270° C., mold temperature of 20 to 50° C., cast rate of 60 mm/s, holding pressure of 10 to 90 MPa, and demolding time of 20 to 60 seconds to obtain a sheet as a molded article.

The resulting sheet having a thickness of 1 mm was annealed in an oven at 80° C. for 24 hours.

Thereafter, the sheet was matured under constant temperature and constant humidity conditions of room temperature of 23° C. and relative humidity of 55% for 7 days.

### Examples 2 to 44 and Comparative Examples 1 to 25

A polyurethane resin composition, pellets, and a sheet were produced in the same manner as in Example 1, except that the formulation was changed to that described in Tables 1 to 16.

In Examples 2 and 20, a tin octylate (catalyst) was not added.

In addition, Stabaxol I-LF (trade name, hydrolysis inhibitor, manufactured by LANXESS AG) was added only when the polyester polyol was used as a high molecular weight polyol.

6) Evaluation

<Bloom Resistance in Humid Heat Environment>

A sheet having a thickness of 1 mm obtained by cast molding was left to stand in a constant temperature and constant humidity oven at 70° C. and 98% RH, and the number of days to powdering phenomenon occurring on the sheet surface was evaluated in five grades with the following evaluations of 5 to 1:

Evaluation 5: no powdering phenomenon occurred within 10 days of the test.

Evaluation 4: powdering phenomenon occurred within 10 days of the test.

Evaluation 3: powdering phenomenon occurred within 5 days of the test.

Evaluation 2: powdering phenomenon occurred within 2 days of the test.

Evaluation 1: powdering phenomenon occurred within 1 day of the test.

<Demoldability (Surface Evaluation of Sheet after Demolding)>

The demolding time at cast molding was unified to 20 seconds in Examples 1 to 18 and Comparative Examples 1 to 12, and 18 seconds in Examples 19 to 44 and Comparative Examples 13 to 25, and a surface state of sheets after demolding was evaluated in five grades with the following evaluations 5 to 1.

Evaluation 5: uniform sheet with no attaching to a mold at the time of demolding and no surface roughness was obtained.

Evaluation 4: though sheet was attached to a mold, a residue of the peeling on the surface of the sheet was below 20% of the entire sheet.

Evaluation 3: sheet was attached to a mold, and a residue of the peeling on the surface of the sheet was 20% or more and below 50% of the entire sheet.

Evaluation 2: sheet was attached to a mold, and a residue of the peeling on the surface of the sheet was 50% or more.

Evaluation 1: at the time of releasing of a mold, sheet was attached to the mold on both sides, and the sheet was broken.

<UV Discoloration Resistance>

A test piece having a size of 20×60 mm was cut out from a sheet having a thickness of 1 mm, and by using a QUV weathering tester attached with an ultraviolet fluorescent light (manufactured by Suga Test Instruments Co., Ltd., ultraviolet fluorescent light weather meter FUV), the conditions of 60° C., relative humidity of 10%, and irradiation intensity of the ultraviolet ray (wavelength of 270 to 720 nm) of 28 W/m² and the conditions of 50° C., relative humidity of 95%, and no ultraviolet irradiation were repeated for 6 cycles every 4 hours for 48 hours. The Ab (changing amount in b-value) of the sheet before and after the test was measured using a color contrast meter (manufactured by Tokyo Denshoku Co., Ltd., Color Ace MODEL TC-1).

<Melting Temperature>

A temperature at which the viscosity of the polyurethane resin composition was 2000 Pa·s was measured by the following method.

That is, the pellets of the polyurethane resin composition were charged into a cylinder equipped with a die having a die size of 1.0 mm and a die length of 10 mm using a Koka-type flow tester CFT-500D (manufactured by SHIMADZU CORPORATION), and the viscosity of the polyurethane resin composition was measured at a temperature rising rate of 25° C./min and a load of 20 kg/cm².

<Transparency>

The transparency of the molded article was measured by the following method.

In other words, the haze of a sheet having a thickness of 1 mm obtained by the cast molding was measured using HAZE METER NDH-5000 (manufactured by NIPPON DENSHOKU INDUSTRIES Co., Ltd.).

TABLE 1

| | | | | | Comparative | Comparative |
|---|---|---|---|---|---|---|
| No. | | | Ex. 1 | Ex. 2 | Ex. 1 | Ex. 2 |
| (a) | 1,4-H6XD1 | | 54.4 | — | — | — |
| [parts by | 4,4′-MDI | | — | 84.6 | — | — |
| mass] | 1,3-H6XDI | | — | — | 54.4 | — |
| | IPDI | | — | — | — | 68.1 |
| (b) | (b1) | PCD #500 | — | — | — | — |
| [parts by | | PCD #1000 | 25 | 25 | 25 | 25 |
| mass] | | PCD #2000 | — | — | — | — |
| | (b2) | PCL #500 | — | — | — | — |
| | | PCL #800 | — | — | — | — |
| | | PCL #1000 | 75 | 75 | 75 | 75 |
| | | PCL #2000 | — | — | — | — |
| | (b3) | PBA #500 | — | — | — | — |
| | | PBA #600 | — | — | — | — |
| | | PBA #1000 | — | — | — | — |
| | | PBA #1200 | — | — | — | — |
| | | PBA #1500 | — | — | — | — |
| | (b4) | PTG #1000 | — | — | — | — |
| | (b′) | 1,4-BD | 16.2 | 21.5 | 16.2 | 18.6 |

| Equivalent Ratio (NCO/OH) | | 1.00 | 1.00 | 1.00 | 1.00 |
|---|---|---|---|---|---|
| Hard Segment | | 30 | 39.3 | 30 | 34.5 |
| Concentration (% by mass) | | | | | |
| Urethane Group | | 3.28 | 3.28 | 3.28 | 3.28 |
| Concentration (mmol/g) | | | | | |
| (c) | Olefin Wax 1 | 0.085 | 0.100 | 0.085 | 0.093 |
| [parts by | Olefin Wax 2 | — | — | — | — |
| mass] | Olefin Wax 3 | — | — | — | — |
| | Acid-Modified | — | — | — | — |
| | Olefin Wax | | | | |
| | Fatty Acid Ester | — | — | — | — |
| | Fatty Acid Amide 1 | — | — | — | — |
| | Fatty Acid Amide 2 | — | — | — | — |
| | Fatty Acid Amide 3 | — | — | — | — |
| Wax (phr) | | 0.05 | 0.05 | 0.05 | 0.05 |
| Evaluation | Humidity Heat | 5 | 5 | 5 | 5 |
| | Bloom Resistance | | | | |
| | Demoldability | 5 | 5 | 2 | 2 |
| | Discoloration | | | | |
| | Resistance (Δb) | 2.8 | 23.1 | 2.5 | 2.9 |

TABLE 2

| | | | | | Comparative |
|---|---|---|---|---|---|
| No. | | | Ex. 3 | Ex. 4 | Ex. 3 |
| (a) | 1,4-H6XDI | | 54.4 | 54.4 | 54.4 |
| [parts by | 4,4′-MDI | | — | — | — |
| mass] | 1,3-H6XDI | | — | — | — |
| | IPDI | | — | — | — |
| (b) | (b1) | PCD#500 | — | — | — |
| [parts by | | PCD#1000 | 15 | 40 | 50 |
| mass] | | PCD#2000 | — | — | — |
| | (b2) | PCL#500 | — | — | — |
| | | PCL#800 | — | — | — |
| | | PCL#1000 | 85 | 60 | 50 |
| | | PCL#2000 | — | — | — |
| | (b3) | PBA#500 | — | — | — |
| | | PBA#600 | — | — | — |
| | | PBA#1000 | — | — | — |
| | | PBA#1200 | — | — | — |
| | | PBA#1500 | — | — | — |
| | (b4) | PTG#1000 | — | — | — |
| | (b′) | 1,4-BD | 16.2 | 16.2 | 16.2 |

| Equivalent Ratio (NCO/OH) | | 1.00 | 1.00 | 1.00 |
|---|---|---|---|---|
| Hard Segment Concentration | | 30 | 30 | 30 |
| (% by mass) | | | | |
| Urethane Group Concentration | | 3.28 | 3.28 | 3.28 |
| (mmol/g) | | | | |
| (c) | Olefin Wax 1 | 0.085 | 0.085 | 0.085 |
| [parts by | Olefin Wax 2 | — | — | — |
| mass] | Olefin Wax 3 | — | — | — |
| | Acid-Modified Olefin | — | — | — |
| | Wax | | | |
| | Fatty Acid Ester | — | — | — |
| | Fatty Acid Amide 1 | — | — | — |
| | Fatty Acid Amide 2 | — | — | — |
| | Fatty Acid Amide 3 | — | — | — |
| Wax(phr) | | 0.05 | 0.05 | 0.05 |
| Evaluation | Humidity Heat Bloom | 3 | 3 | 1 |
| | Resistance | | | |
| | Demoldability | 5 | 4 | 3 |
| | Discoloration | 2.9 | 2.7 | 2.8 |
| | Resistance(Δ b) | | | |

TABLE 3

| | | | Comparative | Comparative | Comparative | | Comparative |
|---|---|---|---|---|---|---|---|
| No. | | | Ex. 4 | Ex. 5 | Ex. 6 | Ex. 5 | Ex. 7 |
| (a) | 1,4-H6XD1 | | 53.0 | 55.1 | 50.3 | 53.4 | 56.4 |
| [parts by | 4,4′-MDI | | — | — | — | — | — |
| mass] | 1,3-H6XDI | | — | — | — | — | — |
| | IPDI | | — | — | — | — | — |
| (b) | (b1) | PCD #500 | 25 | — | — | — | — |
| [parts by | | PCD #1000 | — | — | 25 | 25 | 25 |
| mass] | | PCD #2000 | — | 25 | — | — | — |
| | (b2) | PCL #500 | — | — | 75 | — | — |
| | | PCL #800 | — | — | — | 75 | — |
| | | PCL #1000 | 75 | 75 | — | — | — |
| | | PCL #2000 | — | — | — | — | 75 |
| | (b3) | PBA #500 | — | — | — | — | — |
| | | PBA #600 | — | — | — | — | — |
| | | PBA #1000 | — | — | — | — | — |
| | | PBA #1200 | — | — | — | — | — |
| | | PBA #1500 | — | — | — | — | — |
| | (b4) | PTG #1000 | — | — | — | — | — |
| | (b′) | 1,4-BD | 13.3 | 17.7 | 7.6 | 14.1 | 20.5 |

| Equivalent Ratio (NCO/OH) | | 1.00 | 1.00 | 1.00 | 1.00 | 1.00 |
|---|---|---|---|---|---|---|
| Hard Segment | | 25.3 | 32.3 | 15.2 | 26.5 | 36.6 |
| Concentration (% by mass) | | | | | | |
| Urethane Group | | 3.28 | 3.28 | 3.28 | 3.28 | 3.28 |
| Concentration (mmol/g) | | | | | | |
| (c) | Olefin Wax 1 | 0.089 | 0.084 | 0.079 | 0.084 | 0.088 |
| [parts by | Olefin Wax 2 | — | — | — | — | — |
| mass] | Olefin Wax 3 | — | — | — | — | — |
| | Acid-Modified | — | — | — | — | — |
| | Olefin Wax | | | | | |
| | Fatty Acid Ester | — | — | — | — | — |
| | Fatty Acid Amide 1 | — | — | — | — | — |
| | Fatty Acid Amide 2 | — | — | — | — | — |
| | Fatty Acid Amide 3 | — | — | — | — | |
| Wax (phr) | | 0.05 | 0.05 | 0.05 | 0.05 | 0.05 |
| Evaluation | Humidity Heat | 5 | 2 | 5 | 5 | 1 |
| | Bloom Resistance | | | | | |
| | Demoldability | 2 | 5 | 1 | 3 | 5 |
| | Discoloration | 2.5 | 2.7 | 3.2 | 2.7 | 2.5 |
| | Resistance (Δb) | | | | | |

TABLE 4

| | | | Comparative | | | | Comparative |
|---|---|---|---|---|---|---|---|
| No. | | | Ex. 8 | Ex. 6 | Ex. 7 | Ex. 8 | Ex. 9 |
| (a) | 1,4-H6XD1 | | 50.3 | 51.7 | 54.4 | 55.1 | 55.7 |
| [parts by | 4,4′-MDI | | — | — | — | — | — |
| mass] | 1,3-H6XDI | | — | — | — | — | — |
| | IPDI | | — | — | — | — | — |
| (b) | (b1) | PCD #500 | — | — | — | — | — |
| [parts by | | PCD #1000 | 25 | 25 | 25 | 25 | 25 |
| mass] | | PCD #2000 | — | — | — | — | — |
| | (b2) | PCL #500 | — | — | — | — | — |
| | | PCL #800 | — | — | — | — | — |
| | | PCL #1000 | — | — | — | — | — |
| | | PCL #2000 | — | — | — | — | — |
| | (b3) | PBA #500 | 75 | — | — | — | — |
| | | PBA #600 | — | 75 | — | — | — |
| | | PBA #1000 | — | — | 75 | — | — |
| | | PBA #1200 | — | — | — | 75 | — |
| | | PBA #1500 | — | — | — | — | 75 |
| | (b4) | PTG #1000 | — | — | — | — | — |
| | (b′) | 1,4-BD | 7.6 | 10.5 | 16.2 | 17.7 | 19.1 |

| Equivalent Ratio (NCO/OH) | | 1.00 | 1.00 | 1.00 | 1.00 | 1.00 |
|---|---|---|---|---|---|---|
| Hard Segment | | 15.2 | 20.4 | 30 | 32.3 | 34.5 |
| Concentration (% by mass) | | | | | | |
| Urethane Group | | 3.28 | 3.28 | 3.28 | 3.28 | 3.28 |
| Concentration (mmol/g) | | 0.079 | 0.082 | 0.085 | 0.086 | 0.087 |
| (c) | Olefin Wax 1 | — | — | — | — | — |
| [parts by | Olefin Wax 2 | — | — | — | — | — |
| mass] | Olefin Wax 3 | — | — | — | — | — |
| | Acid-Modified | — | — | — | — | — |
| | Olefin Wax | | | | | |
| | Fatty Acid Ester | — | — | — | — | — |
| | Fatty Acid Amide 1 | — | — | — | — | — |
| | Fatty Acid Amide 2 | — | — | — | — | — |
| | Fatty Acid Amide 3 | — | — | — | — | — |
| Wax (phr) | | 0.05 | 0.05 | 0.05 | 0.05 | 0.05 |
| Evaluation | Humidity Heat | 5 | 5 | 4 | 3 | 1 |
| | Bloom Resistance | | | | | |
| | Demoldability | 1 | 3 | 5 | 5 | 5 |
| | Discoloration | 2.9 | 3.0 | 2.9 | 2.6 | 2.9 |
| | Resistance (Δb) | | | | | |

TABLE 5

| | | | Comparative | Comparative |
|---|---|---|---|---|
| No. | | | Ex. 10 | Ex. 11 |
| (a) | 1,4-H6XDI | | 54.4 | 54.4 |
| [parts by | 4,4′-MDI | | — | — |
| mass] | 1,3-H6XDI | | — | — |
| | IPDI | | — | — |
| (b) | (b1) | PCD#500 | — | — |
| [parts by | | PCD#1000 | 25 | — |
| mass] | | PCD#2000 | — | — |
| | (b2) | PCL#500 | — | — |
| | | PCL#800 | — | — |
| | | PCL#1000 | — | 75 |
| | | PCL#2000 | — | — |
| | (b3) | PBA#500 | — | — |
| | | PBA#600 | — | — |
| | | PBA#1000 | — | — |
| | | PBA#1200 | — | — |
| | | PBA#1500 | — | — |
| | (b4) | PTG#1000 | 75 | 25 |
| | (b′) | 1,4-BD | 16.2 | 16.2 |

| Equivalent Ratio (NCO/OH) | | 1.00 | 1.00 |
|---|---|---|---|
| Hard Segment Concentration | | 30 | 30 |
| (% by mass) | | | |
| Urethane Group Concentration | | 3.28 | 3.28 |
| (mmol/g) | | | |
| (c) | Olefin Wax 1 | 0.085 | 0.085 |
| [parts by | Olefin Wax 2 | — | — |
| mass] | Olefin Wax 3 | — | — |
| | Acid-Modified Olefin | — | — |
| | Wax | | |
| | Fatty Acid Ester | — | — |
| | Fatty Acid Amide 1 | — | — |
| | Fatty Acid Amide 2 | — | — |
| | Fatty Acid Amide 3 | — | — |
| Wax(phr) | | 0.05 | 0.05 |
| Evaluation | Humidity Heat Bloom | 1 | 2 |
| | Resistance | | |
| | Demoldability | 4 | 5 |
| | Discoloration | 2.4 | 2.6 |
| | Resistance(Δ b) | | |

TABLE 6

| No. | | | Ex. 9 | Ex. 10 | Ex. 11 | Ex. 12 | Ex. 13 | Ex. 14 |
|---|---|---|---|---|---|---|---|---|
| (a) | 1,4-H6XD1 | | 54.4 | 54.4 | 54.4 | 54.4 | 54.4 | 54.4 |
| [parts by | 4,4′-MDI | | — | — | — | — | — | — |
| mass] | 1,3-H6XDI | | — | — | — | — | — | — |
| | IPDI | | — | — | — | — | — | — |
| (b) | (b1) | PCD #500 | — | — | — | — | — | — |
| [parts by | | PCD #1000 | 25 | 25 | 25 | 25 | 25 | 25 |
| mass] | | PCD #2000 | — | — | — | — | — | — |
| | (b2) | PCL #500 | — | — | — | — | — | — |
| | | PCL #800 | — | — | — | — | — | — |
| | | PCL #1000 | 75 | 75 | 75 | 75 | 75 | 75 |
| | | PCL #2000 | — | — | — | — | — | — |
| | (b3) | PBA #500 | — | — | — | — | — | — |
| | | PBA #600 | — | — | — | — | — | — |
| | | PBA #1000 | — | — | — | — | — | — |
| | | PBA #1200 | — | — | — | — | — | — |
| | | PBA #1500 | — | — | — | — | — | — |
| | (b4) | PTG #1000 | — | — | — | — | — | — |
| | (b′) | 1,4-BD | 16.2 | 16.2 | 16.2 | 16.2 | 16.2 | 16.2 |

| Equivalent Ratio (NCO/OH) | | 1.00 | 1.00 | 1.00 | 1.00 | 1.00 | 1.00 |
|---|---|---|---|---|---|---|---|
| Hard Segment | | 30 | 30 | 30 | 30 | 30 | 30 |
| Concentration (% by mass) | | | | | | | |
| Urethane Group | | 3.28 | 3.28 | 3.28 | 3.28 | 3.28 | 3.28 |
| Concentration (mmol/g) | | | | | | | |
| (c) | Olefin Wax 1 | — | — | — | — | — | — |
| [parts by | Olefin Wax 2 | 0.085 | — | — | — | — | — |
| mass] | Olefin Wax 3 | — | — | 0.085 | — | — | — |
| | Acid-Modified | — | — | — | — | — | 0.085 |
| | Olefin Wax | | | | | | |
| | Fatty Acid Ester | — | 0.085 | — | — | — | — |
| | Fatty Acid Amide 1 | — | — | — | 0.085 | — | — |
| | Fatty Acid Amide 2 | — | — | — | — | 0.085 | — |
| | Fatty Acid Amide 3 | — | — | — | — | — | |
| Wax (phr) | | 0.05 | 0.05 | 0.05 | 0.05 | 0.05 | 0.05 |
| Evaluation | Humidity Heat | 5 | 5 | 3 | 5 | 3 | 3 |
| | Bloom Resistance | | | | | | |
| | Demoldability | 5 | 5 | 5 | 5 | 5 | 3 |
| | Discoloration | | | | | | |
| | Resistance (Δb) | 2.5 | 2.9 | 2.7 | 3.1 | 3.2 | 2.8 |

TABLE 7

| | | | Comparative | | | | |
|---|---|---|---|---|---|---|---|
| No. | | | Ex. 12 | Ex. 15 | Ex. 16 | Ex. 17 | Ex. 18 |
| (a) | 1,4-H6XD1 | | 54.4 | 54.4 | 54.4 | 54.4 | 54.4 |
| [parts by | 4,4′-MDI | | — | — | — | — | — |
| mass] | 1,3-H6XDI | | — | — | — | — | — |
| | IPDI | | — | — | — | — | — |
| (b) | (b1) | PCD #500 | — | — | — | — | — |
| [parts by | | PCD #1000 | 25 | 25 | 25 | 25 | 25 |
| mass] | | PCD #2000 | — | — | — | — | — |
| | (b2) | PCL #500 | — | — | — | — | — |
| | | PCL #800 | — | — | — | — | — |
| | | PCL #1000 | 75 | 75 | 75 | 75 | 75 |
| | | PCL #2000 | — | — | — | — | — |
| | (b3) | PBA #500 | — | — | — | — | — |
| | | PBA #600 | — | — | — | — | — |
| | | PBA #1000 | — | — | — | — | — |
| | | PBA #1200 | — | — | — | — | — |
| | | PBA #1500 | — | — | — | — | — |
| | (b4) | PTG #1000 | — | — | — | — | — |
| | (b′) | 1,4-BD | 16.2 | 16.2 | 16.2 | 16.2 | 16.2 |

| Equivalent Ratio (NCO/OH) | | 1.00 | 1.00 | 1.00 | 1.00 | 1.00 |
|---|---|---|---|---|---|---|
| Hard Segment | | 30 | 30 | 30 | 30 | 30 |
| Concentration (% by mass) | | | | | | |
| Urethane Group | | 3.28 | 3.28 | 3.28 | 3.28 | 3.28 |
| Concentration (mmol/g) | | | | | | |
| (c) | Olefin Wax 1 | — | 0.002 | 0.017 | 0.171 | 0.512 |
| [parts by | Olefin Wax 2 | — | — | — | — | — |
| mass] | Olefin Wax 3 | — | — | — | — | — |
| | Acid-Modified | — | — | — | — | — |
| | Olefin Wax | | | | | |
| | Fatty Acid Ester | — | — | — | — | — |
| | Fatty Acid Amide 1 | — | — | — | — | — |
| | Fatty Acid Amide 2 | — | — | — | — | — |
| | Fatty Acid Amide 3 | — | — | — | — | — |
| Wax (phr) | | 0 | 0.001 | 0.01 | 0.1 | 0.3 |
| Evaluation | Humidity Heat | 2 | 3 | 4 | 5 | 3 |
| | Bloom Resistance | | | | | |
| | Demoldability | 2 | 3 | 4 | 5 | 3 |
| | Discoloration | 2.9 | 2.6 | 3.0 | 2.9 | 2.7 |
| | Resistance (Δb) | | | | | |

TABLE 8

| | | | | | Comparative | Comparative |
|---|---|---|---|---|---|---|
| No. | | | Ex. 19 | Ex. 20 | Ex. 13 | Ex. 14 |
| (a) | 1,4-H6XD1 | | 53.5 | — | — | — |
| [parts by | 4,4′-MDI | | — | 82.9 | — | — |
| mass] | 1,3-H6XDI | | — | — | 53.5 | — |
| | IPDI | | — | — | — | 66.8 |
| (b) | (b1) | PCD #500 | — | — | — | — |
| [parts by | | PCD #1000 | 10 | 10 | 10 | 10 |
| mass] | | PCD #2000 | — | — | — | — |
| | (b2) | PCL #500 | — | — | — | — |
| | | PCL #800 | — | — | — | — |
| | | PCL #1000 | 90 | 90 | 90 | 90 |
| | | PCL #2000 | — | — | — | — |
| | (b3) | PBA #500 | — | — | — | — |
| | | PBA #600 | — | — | — | — |
| | | PBA #1000 | — | — | — | — |
| | | PBA #1200 | — | — | — | — |
| | | PBA #1500 | — | — | — | — |
| | (b4) | PTG #1000 | — | — | — | — |
| | (b′) | 1,4-BD | | | | |

| Equivalent Ratio (NCO/OH) | | 0.98 | 21.3 | 16.1 | 18.5 |
|---|---|---|---|---|---|
| Hard Segment | | 30 | 39.4 | 30 | 34.5 |
| Concentration (% by mass) | | | | | |
| Urethane Group | | 3.25 | 3.25 | 3.25 | 3.25 |
| Concentration (mmol/g) | | | | | |
| (c) | Olefin Wax 1 | 0.085 | 0.102 | 0.085 | 0.093 |
| [parts by | Olefin Wax 2 | — | — | — | — |
| mass] | Olefin Wax 3 | — | — | — | — |
| | Acid-Modified | — | — | — | — |
| | Olefin Wax | | | | |
| | Fatty Acid Ester | — | — | — | — |
| | Fatty Acid Amide 1 | — | — | — | — |
| | Fatty Acid Amide 2 | — | — | — | — |
| | Fatty Acid Amide 3 | 0.017 | 0.020 | 0.017 | 0.019 |
| Wax (phr) | | 0.060 | 0.060 | 0.060 | 0.060 |
| Evaluation | Humidity Heat | 5 | 5 | 5 | 5 |
| | Bloom Resistance | | | | |
| | Demoldability | 5 | 5 | 2 | 2 |
| | Discoloration | 2.7 | 22.9 | 2.4 | 2.7 |
| | Resistance (Δb) | | | | |
| | Melting Temperature (° C.) | 201 | 195 | 193 | 190 |
| | Transparency Haze Value | 1.9 | 1.6 | 1.8 | 1.7 |

TABLE 9

| | | | Comparative | | | Comparative |
|---|---|---|---|---|---|---|
| No. | | | Ex. 15 | Ex. 21 | Ex. 22 | Ex. 16 |
| (a) | 1,4-H6XD1 | | 53.5 | 53.5 | 53.5 | 53.5 |
| [parts by | 4,4′-MDI | | — | — | — | — |
| mass] | 1,3-H6XDI | | — | — | — | — |
| | IPDI | | — | — | — | — |
| (b) | (b1) | PCD #500 | — | — | — | — |
| [parts by | | PCD #1000 | 1 | 5 | 30 | 50 |
| mass] | | PCD #2000 | — | — | — | — |
| | (b2) | PCL #500 | — | — | — | — |
| | | PCL #800 | — | — | — | — |
| | | PCL #1000 | 99 | 95 | 70 | 50 |
| | | PCL #2000 | — | — | — | — |
| | (b3) | PBA #500 | — | — | — | — |
| | | PBA #600 | — | — | — | — |
| | | PBA #1000 | — | — | — | — |
| | | PBA #1200 | — | — | — | — |
| | | PBA #1500 | — | — | — | — |
| | (b4) | PTG #1000 | — | — | — | — |
| | (b′) | 1,4-BD | 16.1 | 16.1 | 16.1 | 16.1 |

| Equivalent Ratio (NCO/OH) | | 0.98 | 0.98 | 0.98 | 0.98 |
|---|---|---|---|---|---|
| Hard Segment | | 30 | 30 | 30 | 30 |
| Concentration (% by mass) | | | | | |
| Urethane Group | | 3.25 | 3.25 | 3.25 | 3.25 |
| Concentration (mmol/g) | | | | | |
| (c) | Olefin Wax 1 | 0.085 | 0.085 | 0.085 | 0.085 |
| [parts by | Olefin Wax 2 | — | — | — | — |
| mass] | Olefin Wax 3 | — | — | — | — |
| | Acid-Modified | — | — | — | — |
| | Olefin Wax | | | | |
| | Fatty Acid Ester | — | — | — | — |
| | Fatty Acid Amide 1 | — | — | — | — |
| | Fatty Acid Amide 2 | — | — | — | — |
| | Fatty Acid Amide 3 | 0.017 | 0.017 | 0.017 | 0.017 |
| Wax (phr) | | 0.060 | 0.060 | 0.060 | 0.060 |
| Evaluation | Humidity Heat | 1 | 3 | 3 | 1 |
| | Bloom Resistance | | | | |
| | Demoldability | 5 | 5 | 4 | 3 |
| | Discoloration | 3.0 | 2.6 | 2.6 | 2.6 |
| | Resistance (Δb) | | | | |
| | Melting Temperature (° C.) | 204 | 205 | 198 | 200 |
| | Transparency Haze Value | 2.2 | 2.1 | 1.2 | 0.9 |

TABLE 10

| | | | Comparative | Comparative | Comparative | | Comparative |
|---|---|---|---|---|---|---|---|
| No. | | | Ex. 17 | Ex. 18 | Ex. 19 | Ex. 23 | Ex. 20 |
| (a) | 1,4-H6XD1 | | 52.9 | 53.8 | 48.7 | 52.3 | 55.9 |
| [parts by | 4,4′-MDI | | — | — | — | — | — |
| mass] | 1,3-H6XDI | | — | — | — | — | — |
| | IPDI | | — | — | — | — | — |
| (b) | (b1) | PCD #500 | 10 | — | — | — | — |
| [parts by | | PCD #1000 | — | — | 10 | 10 | 10 |
| mass] | | PCD #2000 | — | 10 | — | — | — |
| | (b2) | PCL #500 | — | — | 90 | — | — |
| | | PCL #800 | — | — | — | 90 | — |
| | | PCL #1000 | 90 | 90 | — | — | — |
| | | PCL #2000 | — | — | — | — | 90 |
| | (b3) | PBA #500 | — | — | — | — | — |
| | | PBA #600 | — | — | — | — | — |
| | | PBA #1000 | — | — | — | — | — |
| | | PBA #1200 | — | — | — | — | — |
| | | PBA #1500 | — | — | — | — | — |
| | (b4) | PTG #1000 | — | — | — | — | — |
| | (b′) | 1,4-BD | 15.0 | 16.7 | 5.6 | 13.5 | 21.4 |

| Equivalent Ratio (NCO/OH) | | 0.98 | 0.98 | 0.98 | 0.98 | 0.98 |
|---|---|---|---|---|---|---|
| Hard Segment | | 28.1 | 30.9 | 11.4 | 25.7 | 38.1 |
| Concentration (% by mass) | | | | | | |
| Urethane Group | | 3.25 | 3.25 | 3.25 | 3.25 | 3.25 |
| Concentration (mmol/g) | | | | | | |
| (c) | Olefin Wax 1 | 0.084 | 0.085 | 0.077 | 0.083 | 0.089 |
| [parts by | Olefin Wax 2 | — | — | — | — | — |
| mass] | Olefin Wax 3 | — | — | — | — | — |
| | Acid-Modified | — | — | — | — | — |
| | Olefin Wax | | | | | |
| | Fatty Acid Ester | — | — | — | — | — |
| | Fatty Acid Amide 1 | — | — | — | — | — |
| | Fatty Acid Amide 2 | — | — | — | — | — |
| | Fatty Acid Amide 3 | 0.017 | 0.017 | 0.015 | 0.017 | 0.018 |
| Wax (phr) | | 0.060 | 0.060 | 0.060 | 0.060 | 0.060 |
| Evaluation | Humidity Heat | 5 | 2 | 5 | 5 | 1 |
| | Bloom Resistance | | | | | |
| | Demoldability | 2 | 5 | 1 | 3 | 5 |
| | Discoloration | 2.2 | 2.5 | 3.1 | 2.7 | 2.4 |
| | Resistance (Δb) | | | | | |
| | Melting Temperature (° C.) | 199 | 204 | 202 | 203 | 200 |
| | Transparency Haze Value | 1.4 | 2.5 | 0.9 | 1.4 | 3.8 |

TABLE 11

| | | | Comparative | | | | Comparative |
|---|---|---|---|---|---|---|---|
| No. | | | Ex. 21 | Ex. 24 | Ex. 25 | Ex. 26 | Ex. 22 |
| (a) | 1,4-H6XD1 | | 48.7 | 50.2 | 53.5 | 54.3 | 55.1 |
| [parts by | 4,4′-MDI | | — | — | — | — | — |
| mass] | 1,3-H6XDI | | — | — | — | — | — |
| | IPDI | | — | — | — | — | — |
| (b) | (b1) | PCD #500 | — | — | — | — | — |
| [parts by | | PCD #1000 | 10 | 10 | 10 | 10 | 10 |
| mass] | | PCD #2000 | — | — | — | — | — |
| | (b2) | PCL #500 | — | — | — | — | — |
| | | PCL #800 | — | — | — | — | — |
| | | PCL #1000 | — | — | — | — | — |
| | | PCL #2000 | — | — | — | — | — |
| | (b3) | PBA #500 | 90 | — | — | — | — |
| | | PBA #600 | — | 90 | — | — | — |
| | | PBA #1000 | — | — | 90 | — | — |
| | | PBA #1200 | — | — | — | 90 | — |
| | | PBA #1500 | — | — | — | — | 90 |
| | (b4) | PTG #1000 | — | — | — | — | — |
| | (b′) | 1,4-BD | 5.6 | 9.1 | 16.1 | 17.9 | 19.7 |

| Equivalent Ratio (NCO/OH) | | 0.98 | 0.98 | 0.98 | 0.98 | 0.98 |
|---|---|---|---|---|---|---|
| Hard Segment | | 11.4 | 18.0 | 30 | 32.8 | 35.5 |
| Concentration (% by mass) | | | | | | |
| Urethane Group | | 3.25 | 3.25 | 3.25 | 3.25 | 3.25 |
| Concentration (mmol/g) | | | | | | |
| (c) | Olefin Wax 1 | 0.077 | 0.080 | 0.085 | 0.086 | 0.087 |
| [parts by | Olefin Wax 2 | — | — | — | — | — |
| mass] | Olefin Wax 3 | — | — | — | — | — |
| | Acid-Modified | — | — | — | — | — |
| | Olefin Wax | | | | | |
| | Fatty Acid Ester | — | — | — | — | — |
| | Fatty Acid Amide 1 | — | — | — | — | — |
| | Fatty Acid Amide 2 | — | — | — | — | — |
| | Fatty Acid Amide 3 | 0.015 | 0.016 | 0.017 | 0.017 | 0.017 |
| Wax (phr) | | 0.060 | 0.060 | 0.060 | 0.060 | 0.060 |
| Evaluation | Humidity Heat | 5 | 5 | 4 | 2 | 1 |
| | Bloom Resistance | | | | | |
| | Demoldability | 1 | 3 | 5 | 5 | 5 |
| | Discoloration | 2.9 | 2.8 | 2.6 | 2.3 | 2.7 |
| | Resistance (Δb) | | | | | |
| | Melting Temperature (° C.) | 205 | 203 | 207 | 199 | 200 |
| | Transparency Haze Value | 0.8 | 1.0 | 1.7 | 2.3 | 3.4 |

TABLE 12

| | | | Comparative | Comparative |
|---|---|---|---|---|
| No. | | | Ex. 23 | Ex. 24 |
| (a) | 1,4-H6XDI | | 53.5 | 53.5 |
| [parts by | 4,4′-MDI | | — | — |
| mass] | 1,3-H6XDI | | — | — |
| | IPDI | | — | — |
| (b) | (b1) | PCD#500 | — | — |
| [parts by | | PCD#1000 | 10 | — |
| mass] | | PCD#2000 | — | — |
| | (b2) | PCL#500 | — | — |
| | | PCL#800 | — | — |
| | | PCL#1000 | — | 90 |
| | | PCL#2000 | — | — |
| | (b3) | PBA#500 | — | — |
| | | PBA#600 | — | — |
| | | PBA#1000 | — | — |
| | | PBA#1200 | — | — |
| | | PBA#1500 | — | — |
| | (b4) | PTG#1000 | 90 | 10 |
| | (b′) | 1,4-BD | 16.1 | 16.1 |

| Equivalent Ratio (NCO/OH) | | 0.98 | 0.98 |
|---|---|---|---|
| Hard Segment Concentration | | 30 | 30 |
| (% by mass) | | | |
| Urethane Group Concentration | | 3.25 | 3.25 |
| (mmol/g) | | | |
| (c) | Olefin Wax 1 | 0.085 | 0.085 |
| [parts by | Olefin Wax 2 | — | — |
| mass] | Olefin Wax 3 | — | — |
| | Acid-Modified Olefin | — | — |
| | Wax | | |
| | Fatty Acid Ester | — | — |
| | Fatty Acid Amide 1 | — | — |
| | Fatty Acid Amide 2 | — | — |
| | Fatty Acid Amide 3 | 0.017 | 0.017 |
| Wax(phr) | | 0.060 | 0.060 |
| Evaluation | Humidity Heat Bloom | 1 | 2 |
| | Resistance | | |
| | Demoldability | 4 | 5 |
| | Discoloration | 2.4 | 2.5 |
| | Resistance(Δ b) | | |
| | Melting Temperature (° C.) | 197 | 205 |
| | Transparency Haze Value | 2.1 | 3.3 |

TABLE 13

| No. | | | Ex. 27 | Ex. 28 | Ex. 29 | Ex. 30 |
|---|---|---|---|---|---|---|
| (a) | 1,4-H6XD1 | | 53.1 | 53.3 | 53.7 | 53.9 |
| [parts by | 4,4′-MDI | | — | — | — | — |
| mass] | 1,3-H6XDI | | — | — | — | — |
| | IPDI | | — | — | — | — |
| (b) | (b1) | PCD #500 | — | — | — | — |
| [parts by | | PCD #1000 | 10 | 10 | 10 | 10 |
| mass] | | PCD #2000 | — | — | — | — |
| | (b2) | PCL #500 | — | — | — | — |
| | | PCL #800 | — | — | — | — |
| | | PCL #1000 | 90 | 90 | 90 | 90 |
| | | PCL #2000 | — | — | — | — |
| | (b3) | PBA #500 | — | — | — | — |
| | | PBA #600 | — | — | — | — |
| | | PBA #1000 | — | — | — | — |
| | | PBA #1200 | — | — | — | — |
| | | PBA #1500 | — | — | — | — |
| | (b4) | PTG #1000 | — | — | — | — |
| | (b′) | 1,4-BD | 15.3 | 15.7 | 16.6 | 17.0 |

| Equivalent Ratio (NCO/OH) | | 1.02 | 1.00 | 0.96 | 0.94 |
|---|---|---|---|---|---|
| Hard Segment | | 28.7 | 29.3 | 30.7 | 31.4 |
| Concentration (% by mass) | | | | | |
| Urethane Group | | 3.25 | 3.25 | 3.25 | 3.25 |
| Concentration (mmol/g) | | | | | |
| (c) | Olefin Wax 1 | 0.084 | 0.085 | 0.085 | 0.085 |
| [parts by | Olefin Wax 2 | — | — | — | — |
| mass] | Olefin Wax 3 | — | — | — | — |
| | Acid-Modified | — | — | — | — |
| | Olefin Wax | | | | |
| | Fatty Acid Ester | — | — | — | — |
| | Fatty Acid Amide 1 | — | — | — | — |
| | Fatty Acid Amide 2 | — | — | — | — |
| | Fatty Acid Amide 3 | 0.017 | 0.017 | 0.017 | 0.017 |
| Wax (phr) | | 0.060 | 0.060 | 0.060 | 0.060 |
| Evaluation | Humidity Heat | 3 | 4 | 5 | 5 |
| | Bloom Resistance | | | | |
| | Demoldability | 3 | 4 | 5 | 5 |
| | Discoloration | 2.4 | 2.8 | 3.0 | 2.3 |
| | Resistance (Δb) | | | | |
| | Melting Temperature (° C.) | 236 | 227 | 186 | 167 |
| | Transparency Haze Value | 1.5 | 1.7 | 2.8 | 8.9 |

TABLE 14

| No. | | | Ex. 31 | Ex. 32 | Ex. 33 | Ex. 34 |
|---|---|---|---|---|---|---|
| (a) | 1,4-H6XD1 | | 53.5 | 53.5 | 53.5 | 53.5 |
| [parts by | 4,4′-MDI | | — | — | — | — |
| mass] | 1,3-H6XDI | | — | — | — | — |
| | IPDI | | — | — | — | — |
| (b) | (b1) | PCD #500 | — | — | — | — |
| [parts by | | PCD #1000 | 10 | 10 | 10 | 10 |
| mass] | | PCD #2000 | — | — | — | — |
| | (b2) | PCL #500 | — | — | — | — |
| | | PCL #800 | — | — | — | — |
| | | PCL #1000 | 90 | 90 | 90 | 90 |
| | | PCL #2000 | — | — | — | — |
| | (b3) | PBA #500 | — | — | — | — |
| | | PBA #600 | — | — | — | — |
| | | PBA #1000 | — | — | — | — |
| | | PBA #1200 | — | — | — | — |
| | | PBA #1500 | — | — | — | — |
| | (b4) | PTG #1000 | — | — | — | — |
| | (b′) | 1,4-BD | 16.1 | 16.1 | 16.1 | 16.1 |

| Equivalent Ratio (NCO/OH) | | 0.98 | 0.98 | 0.98 | 0.98 |
|---|---|---|---|---|---|
| Hard Segment | | 30 | 30 | 30 | 30 |
| Concentration (% by mass) | | | | | |
| Urethane Group | | 3.25 | 3.25 | 3.25 | 3.25 |
| Concentration (mmol/g) | | | | | |
| (c) | Olefin Wax 1 | 0.002 | 0.017 | 0.153 | 0.492 |
| [parts by | Olefin Wax 2 | — | — | — | — |
| mass] | Olefin Wax 3 | — | — | — | — |
| | Acid-Modified | — | — | — | — |
| | Olefin Wax | | | | |
| | Fatty Acid Ester | — | — | — | — |
| | Fatty Acid Amide 1 | — | — | — | — |
| | Fatty Acid Amide 2 | — | — | — | — |
| | Fatty Acid Amide 3 | 0.002 | 0.017 | 0.017 | 0.017 |
| Wax (phr) | | 0.002 | 0.020 | 0.100 | 0.300 |
| Evaluation | Humidity Heat | 3 | 4 | 5 | 3 |
| | Bloom Resistance | | | | |
| | Demoldability | 3 | 4 | 5 | 5 |
| | Discoloration | 2.6 | 2.8 | 2.3 | 2.7 |
| | Resistance (Δb) | | | | |
| | Melting Temperature (° C.) | 201 | 205 | 198 | 203 |
| | Transparency Haze Value | 1.7 | 1.8 | 3.2 | 5.6 |

TABLE 15

| No. | | | Ex. 35 | Ex. 36 | Ex. 37 | Ex. 38 | Ex. 39 |
|---|---|---|---|---|---|---|---|
| (a) | 1,4-H6XD1 | | 53.5 | 53.5 | 53.5 | 53.5 | 53.5 |
| [parts by | 4,4′-MDI | | — | — | — | — | — |
| mass] | 1,3-H6XDI | | — | — | — | — | — |
| | IPDI | | — | — | — | — | — |
| (b) | (b1) | PCD #500 | — | — | — | — | — |
| [parts by | | PCD #1000 | 10 | 10 | 10 | 10 | 10 |
| mass] | | PCD #2000 | — | — | — | — | — |
| | (b2) | PCL #500 | — | — | — | — | — |
| | | PCL #800 | — | — | — | — | — |
| | | PCL #1000 | 90 | 90 | 90 | 90 | 90 |
| | | PCL #2000 | — | — | — | — | — |
| | (b3) | PBA #500 | — | — | — | — | — |
| | | PBA #600 | — | — | — | — | — |
| | | PBA #1000 | — | — | — | — | — |
| | | PBA #1200 | — | — | — | — | — |
| | | PBA #1500 | — | — | — | — | — |
| | (b4) | PTG #1000 | — | — | — | — | — |
| | (b′) | 1,4-BD | 16.1 | 16.1 | 16.1 | 16.1 | 16.1 |

| Equivalent Ratio (NCO/OH) | | 0.98 | 0.98 | 0.98 | 0.98 | 0.98 |
|---|---|---|---|---|---|---|
| Hard Segment | | 30 | 30 | 30 | 30 | 30 |
| Concentration (% by mass) | | | | | | |
| Urethane Group | | 3.25 | 3.25 | 3.25 | 3.25 | 3.25 |
| Concentration (mmol/g) | | | | | | |
| (c) | Olefin Wax 1 | — | — | — | — | 0.085 |
| [parts by | Olefin Wax 2 | 0.085 | — | — | — | — |
| mass] | Olefin Wax 3 | — | 0.085 | — | — | — |
| | Acid-Modified | — | — | 0.085 | — | — |
| | Olefin Wax | | | | | |
| | Fatty Acid Ester | — | — | — | 0.085 | 0.085 |
| | Fatty Acid Amide 1 | — | — | — | — | — |
| | Fatty Acid Amide 2 | — | — | — | — | — |
| | Fatty Acid Amide 3 | 0.017 | 0.017 | 0.017 | 0.017 | — |
| Wax (phr) | | 0.060 | 0.060 | 0.060 | 0.060 | 0.100 |
| Evaluation | Humidity Heat | 5 | 5 | 3 | 5 | 5 |
| | Bloom Resistance | | | | | |
| | Demoldability | 5 | 5 | 3 | 2 | 4 |
| | Discoloration | 2.9 | 2.5 | 3 | 2.8 | 2.7 |
| | Resistance (Δb) | | | | | |
| | Melting Temperature (° C.) | 204 | 201 | 200 | 204 | 207 |
| | Transparency Haze Value | 4.4 | 5.8 | 5.5 | 1.8 | 1.9 |

TABLE 16

| | | | | | | | | Comparative |
|---|---|---|---|---|---|---|---|---|
| No. | | | Ex. 40 | Ex. 41 | Ex. 42 | Ex. 43 | Ex. 44 | Ex. 25 |
| (a) | 1,4-H6XD1 | | 53.5 | 53.5 | 53.5 | 53.5 | 53.5 | 53.5 |
| [parts by | 4,4′-MDI | | — | — | — | — | — | — |
| mass] | 1,3-H6XDI | | — | — | — | — | — | — |
| | IPDI | | — | — | — | — | — | — |
| (b) | (b1) | PCD #500 | — | — | — | — | — | — |
| [parts by | | PCD #1000 | 10 | 10 | 10 | 10 | 10 | 10 |
| mass] | | PCD #2000 | — | — | — | — | — | — |
| | (b2) | PCL #500 | — | — | — | — | — | — |
| | | PCL #800 | — | — | — | — | — | — |
| | | PCL #1000 | 90 | 90 | 90 | 90 | 90 | 90 |
| | | PCL #2000 | — | — | — | — | — | — |
| | (b3) | PBA #500 | — | — | — | — | — | — |
| | | PBA #600 | — | — | — | — | — | — |
| | | PBA #1000 | — | — | — | — | — | — |
| | | PBA #1200 | — | — | — | — | — | — |
| | | PBA #1500 | — | — | — | — | — | — |
| | (b4) | PTG #1000 | — | — | — | — | — | — |
| | (b′) | 1,4-BD | 16.1 | 16.1 | 16.1 | 16.1 | 16.1 | 16.1 |

| Equivalent Ratio (NCO/OH) | | 0.98 | 0.98 | 0.98 | 0.98 | 0.98 | 0.98 |
|---|---|---|---|---|---|---|---|
| Hard Segment | | 30 | 30 | 30 | 30 | 30 | 30 |
| Concentration (% by mass) | | | | | | | |
| Urethane Group | | 3.25 | 3.25 | 3.25 | 3.25 | 3.25 | 3.25 |
| Concentration (mmol/g) | | | | | | | |
| (c) | Olefin Wax 1 | 0.085 | 0.085 | 0.085 | — | — | — |
| [parts by | Olefin Wax 2 | — | — | — | — | — | — |
| mass] | Olefin Wax 3 | — | — | — | — | — | — |
| | Acid-Modified | — | — | — | — | — | — |
| | Olefin Wax | | | | | | |
| | Fatty Acid Ester | — | — | — | 0.085 | — | — |
| | Fatty Acid Amide 1 | 0.017 | — | — | — | — | — |
| | Fatty Acid Amide 2 | — | 0.017 | — | — | — | — |
| | Fatty Acid Amide 3 | — | — | — | — | 0.017 | — |
| Wax (phr) | | 0.060 | 0.060 | 0.050 | 0.050 | 0.010 | 0.000 |
| Evaluation | Humidity Heat | 5 | 3 | 5 | 4 | 4 | 2 |
| | Bloom Resistance | | | | | | |
| | Demoldability | 4 | 5 | 4 | 4 | 5 | 2 |
| | Discoloration | 2.9 | 2.5 | 2.6 | 2.3 | 2.7 | 2.5 |
| | Resistance (Δb) | | | | | | |
| | Melting Temperature (° C.) | 203 | 207 | 206 | 207 | 198 | 204 |
| | Transparency Haze Value | 1.8 | 1.7 | 1.8 | 1.8 | 1.8 | 1.7 |

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICATION

The polyurethane resin composition and the molded article of the present invention are, for example, preferably used as a cover for a smart device.

1. A polyurethane resin composition comprising:
a reaction product of a polyisocyanate component and a polyol component, and a wax, wherein
the polyisocyanate component contains a highly symmetrical polyisocyanate;
the polyol component contains a polycarbonate polyol having a number average molecular weight of 600 or more and 1200 or less and a polyester polyol having a number average molecular weight of 600 or more and 1200 or less; and
a ratio of the polycarbonate polyol is 3 parts by mass or more and 40 parts by mass or less, and a ratio of the polyester polyol is 60 parts by mass or more and 97 parts by mass or less with respect to 100 parts by mass of the total amount of the polycarbonate polyol and the polyester polyol.

2. The polyurethane resin composition according to claim 1, wherein
a temperature at which the viscosity of the polyurethane resin composition is 2000 Pa·s is 185° C. or more and 225° C. or less.

3. The polyurethane resin composition according to claim 1, wherein
the highly symmetrical polyisocyanate includes a 1,4-bis(isocyanatomethyl)cyclohexane or a 4,4′-diphenylmethane diisocyanate.

4. The polyurethane resin composition according to claim 1, wherein
the polyisocyanate component includes a 1,4-bis(isocyanatomethyl)cyclohexane.

5. The polyurethane resin composition according to claim 1, wherein
the polyester polyol includes a polycaprolactone polyol.

6. The polyurethane resin composition according to claim 1, wherein
a number average molecular weight of the polycarbonate polyol is 600 or more and 1000 or less, and
a number average molecular weight of the polyester polyol is 1000 or more and 1200 or less.

7. The polyurethane resin composition according to claim 1, wherein
a content ratio of the wax is 0.005 parts by mass or more and 0.15 parts by mass or less with respect to 100 parts by mass of the total amount of the polyisocyanate component and the polyol component.

8. The polyurethane resin composition according to claim 1, wherein
the wax includes at least one kind selected from the group consisting of a polyolefin-based wax, a fatty acid ester-based wax, and a fatty acid amide-based wax.

9. The polyurethane resin composition according to claim 8, wherein
the wax includes a polyolefin-based wax, and
the melt viscosity at 150° C. of the polyolefin-based wax is 10 mPa·s or more and 100 mPa·s or less.

10. The polyurethane resin composition according to claim 8, wherein
the wax includes a fatty acid ester-based wax and/or a fatty acid amide-based wax, and
the melt viscosity at 190° C. of the fatty acid ester-based wax and the fatty acid amide-based wax is 10 mPa·s or more and 100 mPa·s or less.

11. The polyurethane resin composition according to claim 8, wherein
the wax includes two or more kinds selected from the group consisting of a polyolefin-based wax, a fatty acid ester-based wax, and a fatty acid amide-based wax.

12. A molded article comprising:
the polyurethane resin composition according to claim 1.

13. The molded article according to claim 12 being a cover for a smart device.
